(19) United States
(12) Patent Application Publication
(10) Pub. No.: US 2026/0309016 A1
(43) Pub. Date: Oct. 8, 2026

(54) HYDRAULIC FRACTURING METHOD USING LIGHTWEIGHT PROPPANT PARTICLES TO REDUCE EROSION AND IMPROVE CONDUCTIVITY

(71) Applicant: ExxonMobil Technology and Engineering Company, Spring, TX (US)

(72) Inventors: Paul Matthew Spiecker, Manvel, TX (US); James S. BROWN, III, Sugar Land, TX (US); Kendal K. DECKER, Conroe, TX (US); Jason Z. GAHR, Columbus, TX (US); Steven Bruce LONNES, Spring, TX (US); Clifton Hopkins PEYTON, Montgomery, TX (US)

(21) Appl. No.: 19/639,533

(22) Filed: Apr. 6, 2026

Related U.S. Application Data
(60) Provisional application No. 63/784,187, filed on Apr. 6, 2025.
(60) Provisional application No. 63/784,193, filed on Apr. 6, 2025.

(51) Int. Cl. E21B 43/267; C09K 8/80; E21B 34/06; E21B 34/14

(52) U.S. Cl. CPC E21B 43/267; E21B 34/063; E21B 34/142; C09K 8/80; E21B 2200/06; E21B 2200/08

(57) ABSTRACT

A method for performing hydraulic fracturing operation via a wellbore to a subsurface formation is provided. The method comprises providing the wellbore, wherein the wellbore comprises a device having an erosion-prone feature during the hydraulic fracturing operation. The method further comprises pumping a fracturing fluid comprising lightweight proppant (LWP) particles through the wellbore and through a cluster of injection ports into the subsurface formation, thereby creating a plurality of fractures in the subsurface formation, wherein the fracturing fluid contacts the erosion-prone feature.

### CROSS-REFERENCE TO RELATED APPLICATIONS

This application claims priority to U.S. Provisional Application No. 63/784,187, titled “METHOD AND SYSTEM FOR SIMULTANEOUSLY FRACTURING MULTIPLE WELLS,” filed Apr. 6, 2025, and U.S. Provisional Application No. 63/784,193, titled “METHOD AND SYSTEM FOR PERFORMING SIMULTANEOUS HYDRAULIC FRACTURING OPERATION,” filed Apr. 6, 2025, the contents of both of which are hereby incorporated by reference in their entirety.

### TECHNICAL FIELD

The present disclosure relates to hydraulic fracturing operations and proppant particles employed therein, and more particularly to methods for performing low-cluster count per stage fracturing operations, particularly single point fracturing operations, using lightweight proppant particles such as petroleum coke to create larger and more uniform fractures with improved conductivity while reducing erosion of downhole components exposed to proppant particles in the fracturing fluid such as fracturing sleeves.

### BACKGROUND

Hydraulic fracturing is a stimulation technique used to enhance the productivity of hydrocarbon wells by creating fractures within subterranean formations. Proppant particles are included in the fracturing fluid to hold fractures open after hydraulic pressure is released, maintaining conductive pathways for hydrocarbon flow. Conventional proppants such as sand have relatively high densities, which can limit their transport deep into hydraulic fractures, causing them to settle in near-wellbore regions and reducing fracturing effectiveness. Sleeve-based completion systems utilize fracturing sleeves that can be shifted from closed to open positions to expose injection ports. These systems employ isolation devices that engage with designated sleeve(s) to enable sequential fracturing of multiple stages. Low-cluster-count fracturing techniques such as single point fracturing (“SPF”), in which fracturing fluid is pumped through a low number of clusters (e.g., no more than three, only one in SPF) of injection ports per stage at a time, can achieve higher fluid velocities and potentially create larger or more uniform fractures.

However, fracturing sleeves and other downhole tools present erosion concerns for components exposed to proppant particles included in the fracturing fluid. Landing profiles, shoulders, enclosures, and other erosion-prone features on the sleeves and other tools are exposed to high-velocity flow of proppant-laden fluids. In wells with long lateral sections, components located toward the heel of the wellbore experience cumulative exposure from fracturing treatments performed at multiple stages toward the toe. Sand proppants, with their high hardness and high density characteristics, exacerbate erosion of these erosion-prone components, potentially compromising the ability of isolation devices to properly engage with successive sleeves and the performance of the other downhole tools. There is a need, therefore, a method with reduced erosion of the wellbore components. This disclosure satisfies this and other needs.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A first aspect of this disclosure relates to a method for performing hydraulic fracturing operation via a wellbore to a subsurface formation. The method comprises providing the wellbore, wherein the wellbore comprises a device having an erosion-prone feature during the hydraulic fracturing operation. The method further comprises pumping a fracturing fluid comprising lightweight proppant (“LWP”) particles through the wellbore and through a cluster of injection ports into the subsurface formation, thereby creating a plurality of fractures in the subsurface formation, wherein the fracturing fluid contacts the erosion-prone feature.

A second aspect of this disclosure relates to a method for performing hydraulic fracturing to a subsurface formation via a wellbore comprising a plurality of fracturing sleeves. The method comprises deploying an isolation device into the wellbore. The method further comprises engaging the isolation device with a fracturing sleeve in the wellbore. The method further comprises shifting the fracturing sleeve from a closed position to an open position, thereby exposing an injection port. The method further comprises pumping a fracturing fluid through the wellbore and through the exposed injection port into the subsurface formation, thereby creating a plurality of fractures in the subsurface formation.

The foregoing general description of the illustrative embodiments and the following detailed description thereof are merely exemplary aspects and embodiments of the teachings of this disclosure and are not restrictive.

### BRIEF DESCRIPTION OF THE DRAWINGS

Non-limiting and non-exhaustive examples are described with reference to the following drawings.

FIG. 1 is a schematic diagram illustrating multiple wells extracting hydrocarbons from a reservoir, according to various embodiments of the present disclosure.

FIG. 2 is a schematic diagram illustrating a hydraulic fracturing system with a closer view of individual sleeve assemblies, according to various embodiments of the present disclosure.

FIG. 3A is a schematic diagram of a fracturing fluid supply system configured to supply fracturing fluids to one or more wells, according to various embodiments of the present disclosure.

FIG. 3B is a schematic diagram of a fracturing fluid supply system configured to supply fracturing fluids to one or more wells, according to various embodiments of the present disclosure.

FIG. 3C is a schematic diagram of a fracturing fluid supply system configured to supply fracturing fluids to one or more wells, according to various embodiments of the present disclosure.

FIG. 4A is a schematic diagram of a pipe-valve system connecting fluid supply conduits to a pump inlet, according to various embodiments of the present disclosure.

FIG. 4B is a schematic diagram of a pipe-valve system connecting fluid supply conduits to a pump inlet, according to various embodiments of the present disclosure.

FIG. 5 is a process flow diagram illustrating an exemplary process for pumping three hydraulic fracturing fluids to a designated well using the system of FIG. 3A to effect fracturing of a given stage in a designated well, according to various embodiments of the present disclosure.

FIG. 6 is a block diagram illustrating an example control system with a controller for controlling a hydraulic fracturing operation, according to an embodiment.

FIGS. 7A-7B are cross-sectional schematic diagrams illustrating a sleeve assembly in closed and open configurations, in accordance with various embodiments of the present disclosure;

FIGS. 7C-7D are cross-sectional schematic diagrams illustrating a sleeve assembly with an activated isolation device engaged therewith, in accordance with various embodiments of the present disclosure;

FIG. 8 is a flowchart of a method for performing a hydraulic fracturing operation via a wellbore to a subsurface formation, according to various embodiments.

FIG. 9 is a flowchart of a method for performing hydraulic fracturing via a wellbore comprising a plurality of fracturing sleeves, according to various embodiments of the present disclosure.

### DETAILED DESCRIPTION

The following description sets forth exemplary aspects and embodiments of the present disclosure. It should be recognized, however, that such description is not intended as a limitation on the scope of the present disclosure. Rather, the description also encompasses combinations and modifications to those exemplary aspects and embodiments described herein.

In the following detailed description section, the specific examples of the present disclosure are described in connection with preferred aspects and embodiments. However, to the extent that the following description is specific to one or more aspects or embodiments of the present disclosure, this is intended to be for exemplary purposes only and simply provides a description of such aspect(s) or embodiment(s). Accordingly, the present disclosure is not limited to the specific aspects and embodiments described below, but rather, includes all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition those skilled in the art have given that term as reflected in at least one printed publication or issued patent. Further, the present disclosure is not limited by the usage of the terms shown below, as all equivalents, synonyms, new developments, and terms or processes that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., +1%, +5%, +10%, +15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

As used herein, the term “apparent density,” with reference to the density of proppant particles, refers to the density of the individual particles themselves, which may be expressed in grams per cubic centimeter (g/cm³ or g/cc). The apparent density values provided herein are based on the American Petroleum Institute's Recommended Practice 19C (hereinafter “API RP-19C”) standard, entitled “Measurement of Properties of Proppants Used in Hydraulic Fracturing and Gravel-packing Operations” (First Ed. May 2008, Reaffirmed June 2016).

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the term “blast furnace coke” refers to any coal-derived coke suitable for use in a blast furnace for making steel.

As used herein, the term “crush strength,” when used with reference to proppant particles, refers to the uniaxial stress (compressive) load that the proppant particles can withstand prior to crushing (e.g., breaking or cracking). The crush strength values of the present disclosure are based on API RP-19C.

As used herein, the terms “example,” exemplary,” and “embodiment,” when used with reference to one or more components, features, structures, or methods according to the present disclosure, are intended to convey that the described component, feature, structure, or method is an illustrative, non-exclusive example of components, features, structures, or methods according to the present disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present disclosure.

As used herein, the term “flexicoke” refers to the solid concentrated carbon material produced via the FLEXICOKING™ process, which is a thermal cracking process utilizing fluidized solids and gasification for the conversion of heavy, low-grade hydrocarbon feeds into lighter hydrocarbon products (e.g., upgraded, more valuable hydrocarbons). Briefly, the FLEXICOKING™ process integrates a cracking reactor, a heater, and a gasifier into a common fluidized-solids (coke) circulating system. A feed stream (of residua) is fed into a fluidized bed, along with a stream of hot recirculating material to the reactor. From the reactor, a stream containing coke is circulated to the heater vessel, where it is heated. The hot coke stream is sent from the heater to the gasifier, where it reacts with air and steam. The gasifier product gas, referred to as coke gas, containing entrained coke particles, is returned to the heater and cooled by cold coke from the reactor to provide a portion of the reactor heat requirement, which is typically in a range from around 496° C. to around 538° C. A return stream of coke sent from the gasifier to the heater provides the remainder of the heat requirement. The coke meeting the heat requirement is then circulated to the reactor, and the feed stream is thermally cracked to produce light hydrocarbon liquids that are removed from the reactor and recovered using conventional fractionating equipment. Fluid coke is formed from the thermal cracking process and settles (deposits) onto the “seed” fluidized bed coke already present in the reactor. The resultant at least partially gasified coke is flexicoke. In some instances, the coke from the thermal cracking process deposits in a pattern that appears ring-like atop the surface of the seed coke. Flexicoke is continuously withdrawn from the system during normal FLEXICOKING™ processing (e.g., from the reactor or after it is streamed to the heater via an elutriator) to ensure that the system maintains particles of coke in a fluidizable particle size range. Accordingly, flexicoke is a readily available byproduct of the FLEXICOKING™ process.

Relatedly, the terms “wet flexicoke fines” and “dry flexicoke fines” refer to two byproducts of the FLEXICOKING™ process. Such byproducts are collected as particles that were not recovered in the secondary cyclones of the heater. More specifically, the particles are collected first in the tertiary cyclone as dry flexicoke fines, and the smaller particles that travel past the tertiary cyclone are then recovered in the venturi scrubber as wet flexicoke fines.

As used herein, the term “fluid coke” refers to the solid concentrated carbon material remaining from fluid coking. The term “fluid coking” refers to a thermal cracking process utilizing fluidized solids for the conversion of heavy, low-grade hydrocarbon feeds into lighter products (e.g., upgraded hydrocarbons), producing fluid coke as a byproduct. The fluid coking process differs from the FLEXICOKING™ process that produces the flexicoke in that the fluid coking process does not include a gasifier.

As used herein, the term “fly ash” refers to fine particles of ash, dust, and soot that generally consist primarily of silicon dioxide, aluminum oxide, and calcium oxide and are produced as a byproduct of the combustion of pulverized coal, typically within coal-fired electric and steam-generating plants.

The term “fracture” (or “hydraulic fracture”) refers to a crack or surface of breakage within a subterranean (i.e., subsurface) formation, that can be induced by an applied pressure or stress.

As used herein, the term “hydraulic conductivity” refers to the ability of a fluid within a subsurface formation to pass through a fracture including proppant at various stress (or pressure) levels, which is based, at least in part, on the permeability of the proppant deposited within the hydraulic fractures. The hydraulic conductivity values provided herein are based on the American Petroleum Institute's Recommended Practice 19D (API RP-19D) standard, entitled “Measuring the Long-Term Conductivity of Proppants” (First Ed. May 2008, Reaffirmed May 2015).

As used herein, the term “metallurgical coke” refers to a type of coal-derived coke that is produced by heating coal, which causes fixed carbon to fuse to inherent ash and drives off a large percentage of the volatile matter. The resulting metallurgical coke particles include a range of different sizes, with the smallest particles being a fine powder (sometimes referred to as “coke breeze”).

The term “particle size(s),” when used herein with reference to a type of particles, refers to the diameter(s) of such particle(s). The term “particle size distribution,” when used herein with reference to a type or a collection of particles, refers to the range of diameters for such particles, typically from the minimal to the maximal. The terms “average particle size distribution” and “D50,” when used herein with reference to a type or a collection of particles, interchangeably mean the median particle size of the particles, i.e., a diameter at which 50% of the sample, on a volume basis unless otherwise specified, is comprised of particles having a diameter less than said diameter value. Particle size can be determined by light scattering techniques or analysis of optical digital micrographs, or using a mass determination process by passing a sample of the particles through a stack of sieves with increasingly smaller mesh sizes, measuring masses of each fraction retained by each sieve, plotting a size distribution diagram, and determining the D50 from the diagram.

The term “petroleum coke” refers to a final carbon-rich solid material that is derived from oil refining. More specifically, petroleum coke is the carbonization product of high-boiling hydrocarbon fractions that are obtained as a result of petroleum processing operations. Petroleum coke is produced within a coking unit via a thermal cracking process in which long-chain hydrocarbons are split into shorter-chain hydrocarbons. As described herein, there are at least three main types of petroleum coke: delayed coke, fluid coke, and flexicoke. Each type of petroleum coke is produced using a different coking process; however, all three coking processes have the common objective of maximizing the yield of distillate products within a refinery by rejecting large quantities of carbon in the residue as petroleum coke.

The term “coal-derived coke” means any coke prepared from coal by, e.g., thermal treatment.

As used herein, the terms “proppant” and “proppant particle” refer to a solid material capable of maintaining open an induced fracture during and following a hydraulic fracturing treatment. The term “proppant pack” refers to a collection of proppant particles.

The terms “coke proppant” and “coke proppant particles” refer to a proppant based on or derived from a solid carbonaceous material produced from treating a carbon-containing material (e.g., oil (e.g., crude oil, vacuum pipestill, and the like), coal, and hydrocarbons) at an elevated temperature in an oxygen deficient environment. The elevated temperature can be at least 200, 250, 300, 350; 400, 450, 500, 600, 700, 800, 900, or even 1000° C. The carbonaceous material comprises the carbon element and optionally additional elements including but not limited to hydrogen, sulfur, vanadium, iron, and the like. The carbonaceous material preferably comprises the carbon element at a concentration of ≥50 wt %, e.g., from 50, 55, 60, 65, 70, wt %, to 75, 80, 85, 90, 95 wt %, to 96, 97, 98, 99 wt %, or even 100 wt %, based on the total weight of all elements in the carbonaceous material. The carbonaceous material preferably comprises the carbon element and hydrogen element at a combined concentration of ≥55 wt %, e.g., from 55, 60, 65, 70, wt %, to 75, 80, 85, 90, 95 wt %, to 96, 97, 98, 99 wt %, or even 100 wt %, based on the total weight of all elements in the carbonaceous material.

The term “non-coke proppant” means any proppant that does not comprise coke proppant particles. Examples of non-coke proppant include sand, ceramic proppants, glass proppants, and polymer proppants.

The term “lightweight proppant (LWP)” refers to proppants having an apparent density within a range of from around 1.2 g/cm³ to around 2.2 g/cm³ (e.g., from around 1.2, 1.3, 1.4, 1.5, 1.6 g/cm³ to around 1.7, 1.8, 1.9, 2.0, 2.1, 2.2 g/cm³), while the term “ultra-lightweight proppant (ULWP)” refers to proppants having an apparent density within a range from around 0.5 g/cm³ to around 1.2 g/cm³ (e.g., from around 0.5, 0.6, 0.7, 0.8 g/cm³ to around 0.9, 1.0, 1.1, 1.2 g/cm³). A coke proppant may or may not be an LWP. The term “non-LWP proppant” refers to proppants having apparent density higher than 2.2 g/cm³ (e.g., from around 2.3, 2.4, 2.5 to around 2.6, 2.8, 3.0, to 3.2, 3.4, 3.5 g/cm³.) A non-coke proppant may or may not be a non-LWP.

The term “microproppant” means proppant particles having particle sizes of at most 105 μm (140 mesh). The term “microproppant coke particles” means a collection of coke particles having particle sizes of at most 105 μm, but potentially within a range from around 0.0001 μm to 105 μm (e.g., from around 0.0001, 0.001, 0.01, 0.1 μm to 0.5, 1.0, 2.0, 5.0, 8.0 10 μm, to 15, 20, 25, 30, 35, 40, 45 μm, to 50, 53, 55, 60, 63, 65 μm, to 74, 75, 80, 85, 88, 90, 95, 100, 105 μm).

The term “petroleum coke proppant particles” means a collection of coke proppant particles that are derived from a petroleum coke source material. The term “petroleum coke fines” means a collection of microproppant coke particles that are derived from a petroleum source material.

As used herein, the term “pyrolysis coke” refers to a type of coke that is generated via hydrocarbon pyrolysis at pyrolysis temperatures higher than the coking processes for making petroleum coke.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

The term “substantially free” or “essentially free” when used with reference to a component of a composition, interchangeably means that the composition comprises the component at a concentration of ≤10 wt %, ≤5 wt %, ≤3 wt %, ≤1 wt %, or 0 wt %, based on the total weight of the composition.

As used herein, the term “thermally post-treated coke” refers to petroleum coke that has been heated to temperatures in a range from around 400° C. to 1200° C. (e.g., from around 400, 500, 600° C., to 700, 800, 900° C., to 1000, 1100, 1200° C.) for a predetermined duration that is in a range from around 1 minute to around 24 hours (e.g., from around 1 minute, 30 minutes, 1 hour, to 4 hours, 8 hours, 12 hours, to 16 hours, 20 hours, 24 hours).

The settling rate of a proppant particle within a fracturing fluid at least in part determines its transport capacity within a hydraulic fracture. The settling rate of a proppant particle can be determined using the following equation:

$$v = \frac{{ρ}_{p} - {ρ}_{f}}{18 η} g {σ}^{2}$$

Where v is the proppant particle, ρₚ−ρ_{f} is proportional to the density difference between the proppant particle and the carrier fluid, n is the viscosity of the carrier fluid, g is the gravitational constant, and σ² is proportional to the square of the proppant particle size.

The term “wellbore” refers to a borehole drilled into a subterranean formation. The borehole may include vertical, deviated, highly deviated, and/or lateral sections. The term “wellbore” also includes the downhole equipment associated with the borehole, such as the casing strings, production tubing, gas lift valves, and other subsurface equipment. Relatedly, the term “hydrocarbon well” (or simply “well”) includes the wellbore in addition to the wellhead and other associated surface equipment.

Certain embodiments and features are described herein using a set of numerical upper limits and a set of numerical lower limits. It should be appreciated that ranges from any lower limit to any upper limit are contemplated unless otherwise indicated. All numerical values are “about”, “around,” or “approximately” the indicated value, and account for experimental errors and variations that would be expected by a person having ordinary skill in the art.

The present disclosure provides methods for performing hydraulic fracturing operations via a wellbore to a subsurface formation, wherein the wellbore comprises a device having an erosion-prone feature, and a fracturing fluid comprising lightweight proppant (“LWP”) particles is pumped through the wellbore and contacts the erosion-prone feature. The sleeve 154 can also comprise an inner diameter restriction at the landing seat location, where the bore of the sleeve narrows to accommodate the landing profile. This inner diameter restriction can create flow disturbances, such as turbulence, as high-velocity proppant-laden fluid flows through the narrowing, which can cause proppant particles to deviate from fluid flow streamlines and impact sleeve surfaces at that location, increasing erosion potential at the landing seat.

### TECHNICAL BACKGROUND

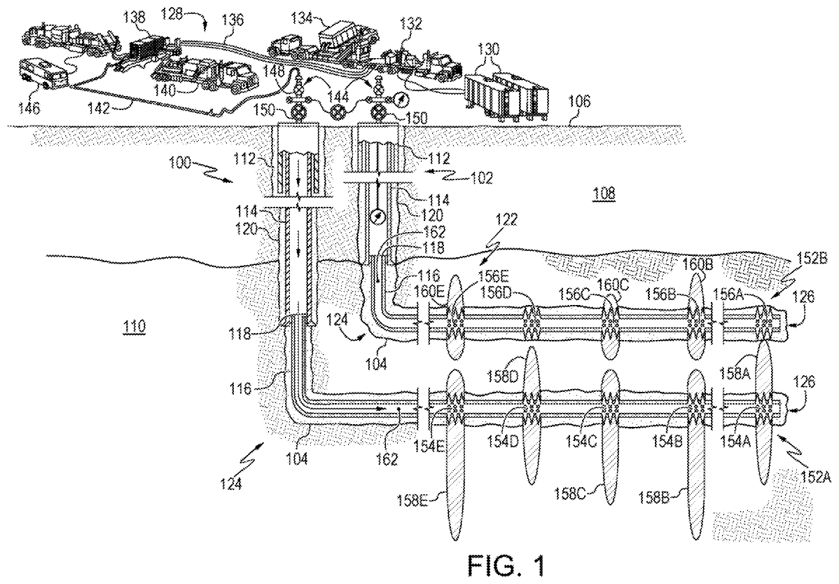

FIG. 1 is a schematic view of an exemplary embodiment of multiple wells extracting hydrocarbons from a reservoir. FIG. 1 shows a first well 100 and a second well 102. The first well 100 and the second well 102 each define corresponding wellbores 104 that extend from a surface 106 into a formation 108 within the subsurface. The formation 108 may include several subsurface intervals, such as a hydrocarbon-bearing interval that is referred to herein as a reservoir 110. In some embodiments, the reservoir 110 is an unconventional, tight reservoir, meaning that it has regions of low permeability. For example, the reservoir 110 may include tight sandstone, tight carbonate, shale gas, coal bed methane, tight oil, and/or tight limestone.

Each wellbore 104 is completed by setting a series of tubulars into the formation 108. These tubulars include several strings of casing, such as a surface casing string 112, an intermediate casing string 114, and a production casing string 116. As used herein, the term “production casing string” is intended to also include production liners. The production casing string 116 may have a first segment having a substantially similar nominal inner diameter (D1). The production casing string 116 for the first well 100 may have a second segment with a substantially similar nominal inner diameter (D2) that is different from D1. The first segment preferably comprises at least two (e.g., 2, 3, 4, 5, 6, 7, 8, 9, 10, 15, 20, 25, 30, 35, 40, 45, 50, 100, 200, 300, 400, 500, 600, 700, 800, 900, 1000, 1200, 1400, 1500, 1600, 1800, 2000, 2500, 3000), or even more openable sleeves. The second segment preferably comprises at least one, e.g., 2, 3, 5, 8, 10, 15, 20, 30, 35, 40, 45, 50, 100, 200, 300, 400, 500, 600, 700, 800, 900, 1000, 1200, 1400, 1500, 1600, 1800, 2000, 2500, 3000, or even more openable sleeves. For example, the production casing string 116 may comprise a first segment with inner diameter of D1 in proximity to the toe and a second segment with inner diameter D2 in proximity to the heel, where D1<D2. In such embodiments, the isolation devices for the first segment may have a larger outer diameter or outer profile than the isolation devices for the second segment, after the isolation devices engage with the respective designated sleeves. Further, different segments of different wells may have similar or different substantially similar nominal inner diameters.

By way of example, a substantially similar nominal inner diameter of a particular segment of a production casing string can be in the range from 3 inches and 10 inches, e.g., from 3 to 6 inches, from 5 to 8 inches, or from 7 to 10 inches. Within a given segment of the production casing string, such as the first segment or the second segment, the substantially similar inner diameter may vary in a range, as long as the variation does not impede (i) the desired travel of the intended isolation devices of a uniform external dimension, and (ii) the desired engagement of the isolation devices with the designated sleeves. In certain embodiments, the inner diameter of a segment of the production casing string having substantially similar nominal inner diameter may vary from Ida−1 cm to Ida+1 cm, or from Ida−0.5 cm to Ida+0.5 cm, or from Ida−0.2 cm to Ida+0.2 cm, where Ida is the average inner diameter of the segment.

In some embodiments, additional intermediate casing strings (not shown) are also included to provide support for the walls of the wellbore 104. According to the embodiment shown in FIG. 1, the surface casing string 112 and the intermediate casing string 114 are hung from the surface 106, while the production casing string 116 is hung from the bottom of the intermediate casing string 114 using a liner hanger 118. The surface casing string 112 and the intermediate casing string 114 may be set in place using cement 120. The production casing string 116 may also be set in place using cement 120, as shown in FIG. 1. Alternatively, the wellbore 104 may be set as an open-hole completion, meaning that the production casing string 116 is not set in place using cement. The exemplary wellbores 104 shown in FIG. 1 may be independently completed horizontally (i.e., the heel 124 and toe 126 are substantially at the same depth in the formation 108), or slanted (i.e., the heel 124 and toe 126 are at differing depth in the formation 108). A lateral section, horizontal or slanted, of each wellbore 104 is shown at 122. Each lateral section 122 has a heel 124 and a toe 126 that extends through the reservoir 110 within the formation 108. In various embodiments where the reservoir 110 is an unconventional, tight reservoir, a hydraulic fracturing process is performed to allow hydrocarbon fluids to be economically produced from the reservoir 110.

The hydraulic fracturing process may utilize an extensive amount of equipment at a well site 128 located at the surface 106. The equipment may include fluid storage tanks 130 to hold clean fracturing fluid (such as water, produced water, treated produced water, slickwater, with or without various additives such as viscosity modifiers, biocides, scale inhibitors, and the like). Preferably, the clean fracturing fluid is substantially free of any proppant particles. The equipment may further include supply sources of slurried fracturing fluids comprising, in addition to carrier fluids, proppant particles of various compositions and/or concentrations. An exemplary supply source of such slurried fracturing fluids is a blenders 132, which may receive a carried fluid such as a clean fracturing fluid described above from tank 130, and a precursor material 134 comprising the proppants (e.g., solid proppant particles per se, a precursor slurry comprising the proppant particles, and the like), and blend them to form a slurried fracturing fluid 136 having a low pressure. The low-pressure slurry 136 may be run through a treater manifold 138, which may use pumps 140 to adjust flow rates, pressures, and the like, creating a high-pressure slurry 142. According to embodiments described herein, the high-pressure slurry 142 can be, via various valves, preferably remotely controllable valves, pumped down the wellbores 104 of the first well 100 and/or the second well 102 via a corresponding wellhead 144 (which can include a valve as described above) and used to fracture the rocks in the reservoir 110. Moreover, a mobile command center 146 may be used to control the hydraulic fracturing process to the multiple wells simultaneously.

Each wellhead 144 may include any arrangement of pipes and valves for controlling the corresponding well 100 or 102. In some embodiments, the wellhead 144 can include a so-called “Christmas tree.” A Christmas tree is typically used when the subsurface formation 108 has enough in-situ pressure to drive hydrocarbon fluids from the reservoir 110, up the corresponding wellbore 104, and to the surface 106, upon completion of the wells during the production phase. The illustrative wellhead 144 can include a top valve 148 and a bottom valve 150. A valve system that may include the top valves 148 and bottom valves 150, among others, may be configured to provide fracturing fluid, including the high-pressure slurry 142 simultaneously to both the first well 100 and the second well 102.

Traditionally, hydraulic fracking can be performed to just one well at a time from a given fleet of pumping equipment. Thus, at any given time, any high-pressure slurry 142 could only be pumped into the production casing string of a single well 104. Simultaneously pumping the same or differing fracturing fluids to multiple wells to provide economic simultaneous hydraulic fracturing of multiple wells have hitherto been extremely challenging. This is partly due to the complexity and difficulty of supplying high-pressure fluids into multiple wells, and the necessity of stopping pumping into one or more wells from time to time using conventional fracking technology such as perf-and-frack. The methods and systems of this disclosure can provide simultaneous hydraulic fracturing operations with respect to multiple wells, such as two, three, four, five, six, seven, eight, nine, ten, or even more wells, preferably from the same fleet of pumping equipment, such as a fleet congregating around a well pad.

A first fracturing stage 152A of the first well 100 is located near the toe 126 of the lateral section 122. A first fracturing stage 152B of the second well 102 is located near the toe 126 of the second well 102. A plurality of sleeves 154A, 154B, 154C, 154D and 154E are installed in the production casing string 116 of the first well 100. A plurality of sleeves 156A, 156B, 156C, 156D and 156E are installed in the production casing string 116 of the second well 102. Distances between adjacent sleeves may be the same or different in the same well. Distances between adjacent sleeves may be the same or different in both wells 100 and 102.

Each of the sleeves 154 and 156 comprises a shiftable mechanism capable of shifting position upon being engaged with an isolation device 162. Thus, in certain embodiments, before engaging with an isolation device, the shiftable mechanism is in a first position resulting in ports on the sleeves being closed. Once an isolation device engages with the sleeve, the shiftable mechanism shifts to a second position due to, e.g., movement of the isolation device pushed by the pumping fluid, exposing and opening the open ports on the sleeves. High-pressure fracturing fluid, e.g., clean fluid or slurried fluid, may be then pumped into the production casing string, which exits the open ports on the open sleeve with sufficient pressure to effect hydraulic fracturing of the reservoir, because the isolation device engaged with the sleeve also forms a sealed plug preventing the fracturing fluid from flowing further downhole along the production casing string. Each sleeve may comprise, e.g., 2, 3, 4, 5, 6, 7, 8, 9, 10, or more open ports. Desirably, the ports on a designated sleeve have substantially uniform dimensions and shapes. Without intending to be bound by any particular theory, uniform dimensions and shapes of the ports and uniform distance between adjacent openings can result in highly uniform fractures and higher hydrocarbon production rate from the well. The number of ports, port size, and port shape may be the same or different among multiple sleeves. Exemplary sleeves suitable for the processes and systems of this disclosure are provided in e.g., U.S. Pat. No. 9,683,419, the relevant contents in which are incorporated herein by reference in their entirety.

In an exemplary embodiment, each of the sleeves 154, 156 may have any desirable length, e.g., from 2 feet to 5 feet. The distance between any two adjacent sleeves can be substantially the same or vary, and can be any length ranging from, for example, from 10 feet and 60 feet, such as 10, 15, 20, 25, 30, 35, 40, 45, 50, 55, 60 feet. In some embodiments, spacing between adjacent sleeve can exceed 60 feet, and may reach 100 feet.

In certain embodiments, a well may comprise at least 100 fracturing stages, e.g., from 100, 150, 200, 350, 300, 350, 400, 450, 500, to 600, 700, 800, 900, 1000, to 1100, 1200, 1300, 1400, 1500, to 1600, 1700, 1800, 1900, 2000, or even more, fracturing stages, depending on sleeve spacing and lateral length of the particular well. Each of the sleeves 154, 156, or groups of successive sleeves, may correspond to a different fracturing stage.

As shown, the sleeves 154A, 154B, 154C, 154D and 154E of the first well 100 may be used to create fractured zones 158A, 158B, 158C, 158D and 158E, respectively. The sleeves 156A, 156B, 156C, 156D and 156E of the second well 102 may be used to create fractured zones 160A, 160B, 160C, 160D and 160E, respectively. While only five sleeves and five fractured zones are shown for each well, each of the first well 100 and the second well 102 may include many more sleeves and many more fractured zones corresponding to the sleeves, as described above.

In some embodiments, particularly where wells 100 and 102 are in proximity to each other, the fractures in the fractured zones 158 of the first well 100 and the fractures in the fractured zones 160 of the second well 102 may approximately align with each other. Alternatively, particularly where wells 100 and 102 are in proximity to each other, the fractures in fractured zones 158 of the first well 100 and the fractures in fractured zones 160 of the second well 102 may be offset to a certain extent or to be spaced from each other with a certain distance.

In various embodiments, the high-pressure slurry 142 of fracturing fluid may be pumped down the wellbores 104 of both the first well 100 and the second well 102 at the same time or at different times, preferably independently from each other pursuant to the individual operation schedule of each well. The fractures 158 and 160 may desirably extend through the formation 108 and into the surrounding reservoir 110. The isolation device comprises a coding device pairing the isolation device 162 with the designated sleeve to which it is pumped. In certain embodiments, the methods of this disclosure includes counting the sleeves the isolation device passes or reaches during step (B1) using the coding device. The counting may be performed inside the isolation device by a device, such as an electrical or mechanical device embedded in the isolation device. Thus, if an isolation device needs to pass a given number of sleeves before it reaches the designated sleeve, it may count the numbers of sleeves passed en route, and stop when the number indicates it has reached the destination designated sleeve. The magnetic sensing component may include a conductive wire coil, and each of the sleeves 154, 156 may include a magnet. The conductive wire coil produces an electric response to the magnet in proximity to the magnet, and the electric response can be used for counting the sleeves.

In other embodiments, the coding device may, for example, include an accelerometer that provides a signal when the isolation device is in proximity to a sleeve, and the signal can be used for counting the sleeves. The signal may be produced, e.g., by contact between a sleeve and the isolation device differing from contact between the isolation device and sections of the production casing string other than the sleeves. In other embodiments, each sleeve 154, 156 may include a radioactive marker. The isolation device 162 can be equipped with a reader that detects the radioactive marker, and the detection of sleeves can be used for counting the sleeves and/or identify individual sleeves. In an exemplary embodiment, the radioactive marker comprises a Pipeline Inspection Point (PIP) tag.

In still another alternative embodiment, the coding device may include an RFID tag, and each of the sleeves 154, 156 may include an RFID reader. In such an embodiment, the RFID reader may communicate with the RFID tag to effect the pairing. Alternatively, the coding device may include an RFID reader, each of the sleeves 154, 156 may include an RFID tag, and the RFID reader may communicate with the RFID tag to effect the pairing. The RFID/reader interaction may be used for counting the sleeves or identifying individual sleeves.

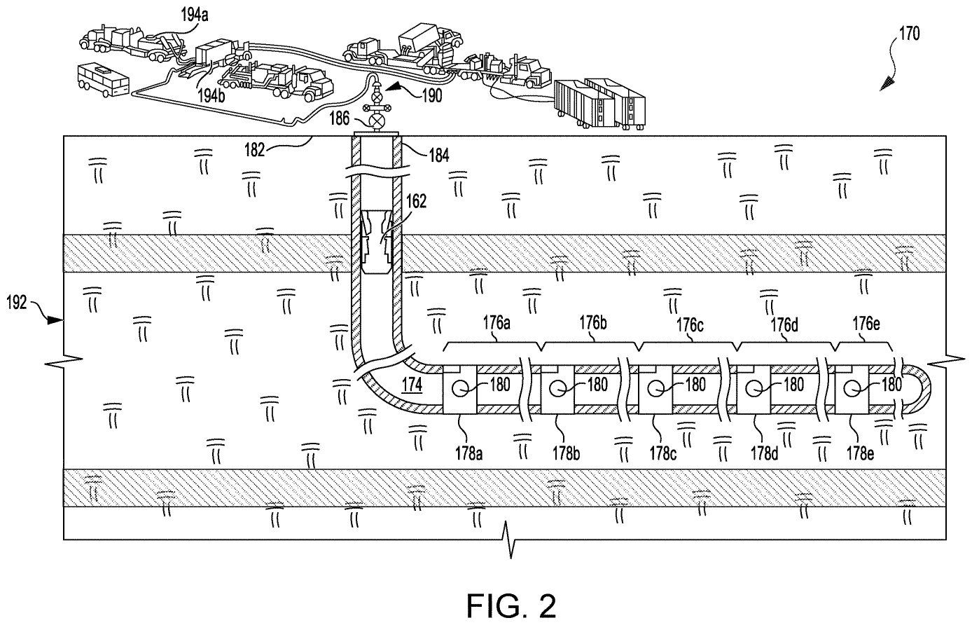

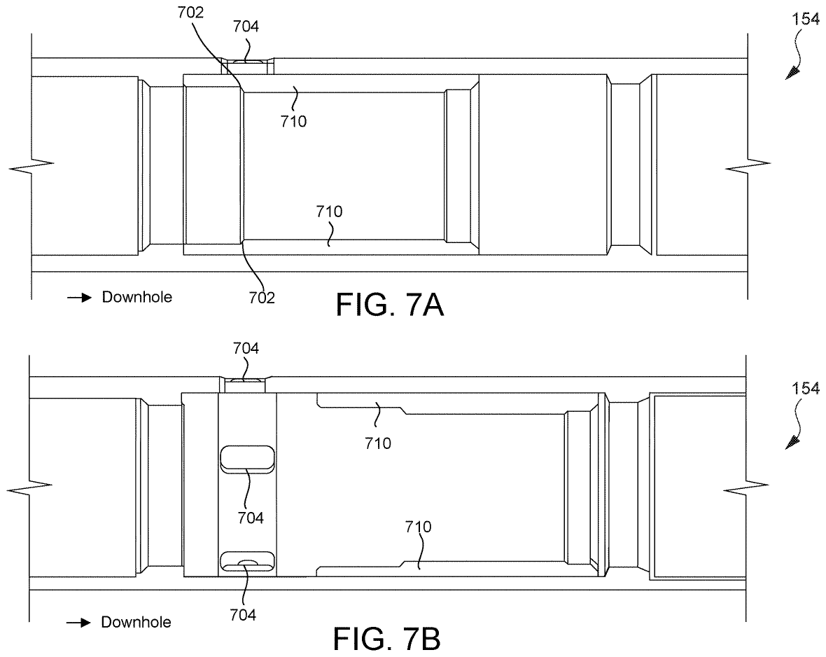

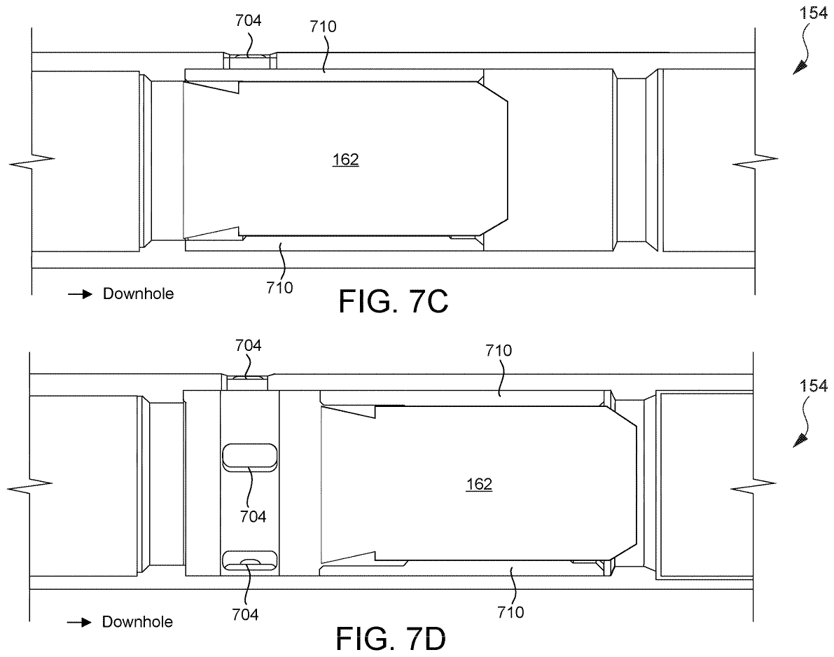

FIG. 2 is a schematic diagram of a hydraulic fracturing system 170, similar to the embodiment shown in FIG. 1, with a closer view of individual sleeve assemblies. The hydraulic fracturing system 170 includes a wellbore string 174 extending from a surface 182 downward into a subsurface formation 192. At the surface 182, the hydraulic fracturing system 170 includes a wellhead 184, a first valve 186, and a valve system 190 configured to control fluid flow into and out of the wellbore string 174. Along a horizontal or lateral section of the wellbore string 174, the hydraulic fracturing system 170 includes a plurality of sleeve assemblies 176 (see also sleeve 154 in FIGS. 1, 7A, and 7B). These include a first sleeve assembly 176a, a second sleeve assembly 176b, a third sleeve assembly 176c, a fourth sleeve assembly 176d, and a fifth sleeve assembly 176e. Each of the sleeve assemblies 176a, 176b, 176c, 176d, and 176e includes a flow port 180 that provides fluid communication between the interior of the wellbore string 174 and the surrounding subsurface formation 192. Although only five sleeve assemblies are illustrated in FIG. 1 for the convenience of description, it is to be understood that in a typical unconventional wellbore, any number of sleeve assemblies, including tens, hundreds, or even thousands of such sleeve assemblies may be included. The fractured well system 170 further includes multiple fracture zones extending from the wellbore string 174 into the subsurface formation 192. A first fracture zone 178a is associated with the first sleeve assembly 176a, a second fracture zone 178b is associated with the second sleeve assembly 176b, a third fracture zone 178c is associated with the third sleeve assembly 176c, a fourth fracture zone 178d is associated with the fourth sleeve assembly 176d, and a fifth fracture zone 178e is associated with the fifth sleeve assembly 176e. Each fracture zone 178a, 178b, 178c, 178d, and 178e represents an area of the subsurface formation 192 that has been fractured through the corresponding flow port 180 to enhance hydrocarbon recovery. During a hydraulic fracturing operation, an isolation device 162 can be passed into the wellbore string 174 such that it may engage with at least one of the sleeve assemblies to facilitate the hydraulic fracturing operation to be performed to the subsurface formation 192.

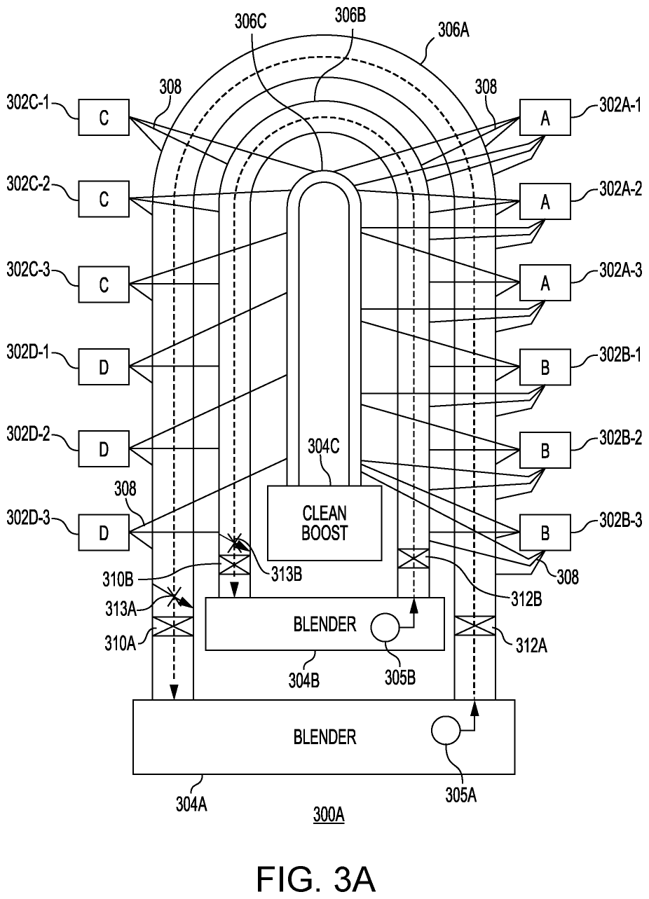

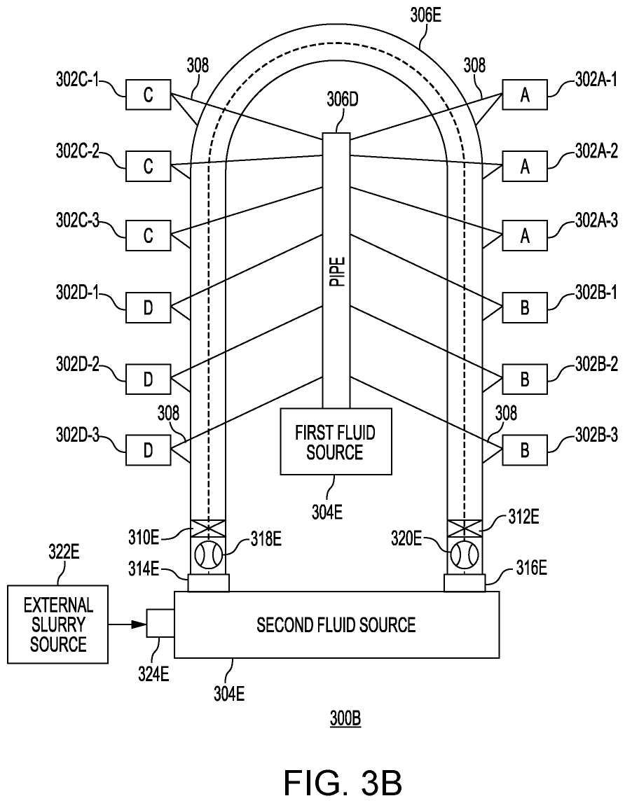

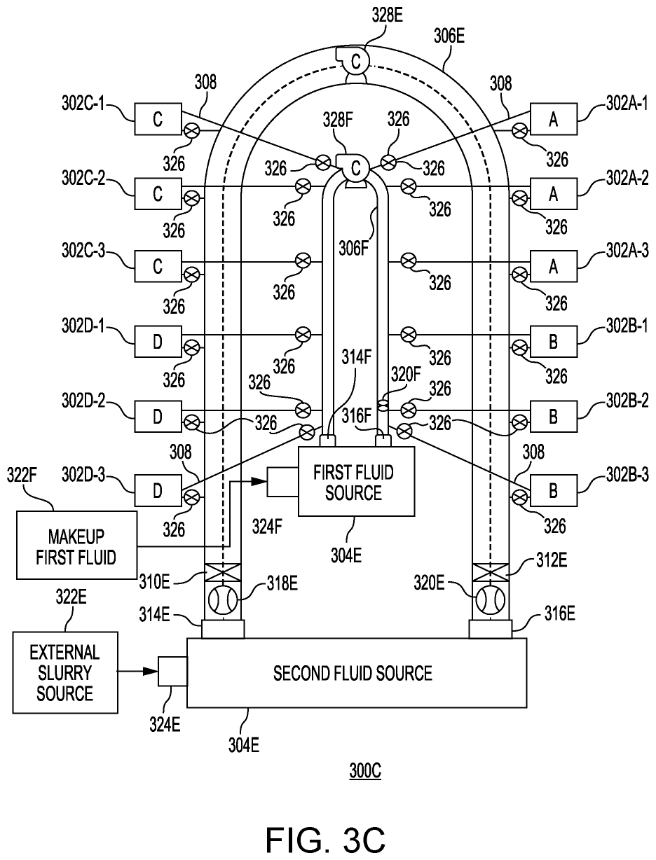

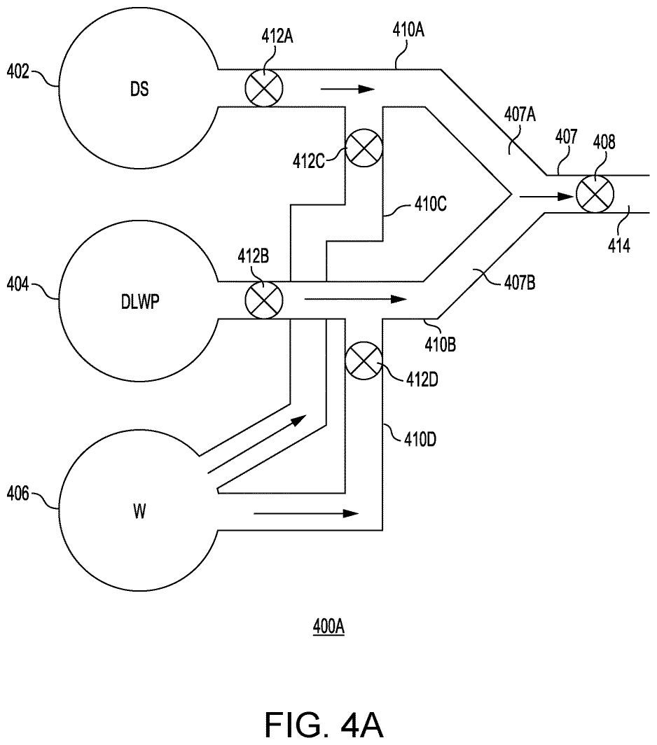

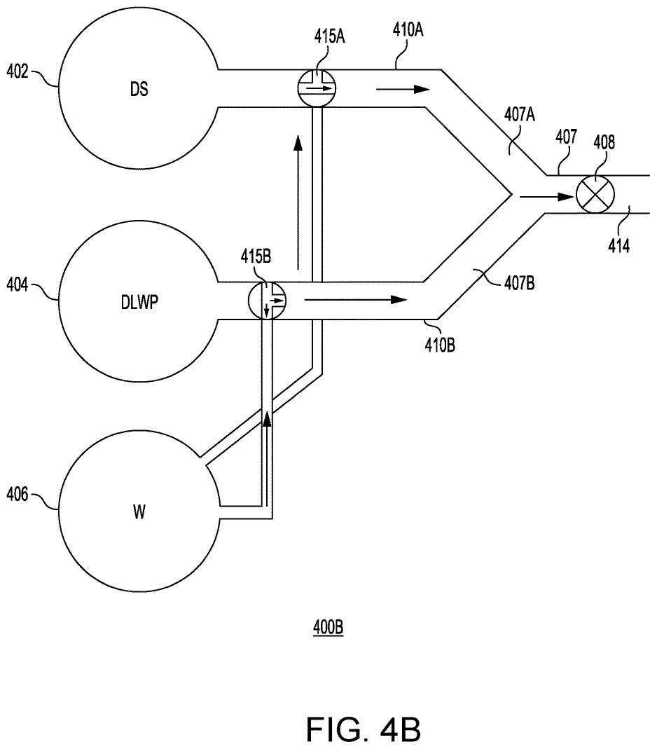

The fracturing system (which may be an SPF system) 170 shown in FIG. 2 may be supplied with fracturing fluids from a fracturing fluid supply system as described with reference to FIGS. 3A, 3B, 3C, 4A, and -4B. The pump 194a and the pump 194b shown in FIG. 2 may receive fracturing fluids from one or more fluid cycling conduits and fluid supply conduits, including but not limited those illustrated in FIGS. 3A, 3B, and -3C and described below. The pipe-valve systems shown in FIGS. 4A and 4B may connect the fluid cycling conduits to pump inlets of the pump 194a and the pump 194b, enabling selective supply of different fracturing fluids to the well 204. In some cases, the fracturing fluid supply systems 300A, 300B, and 300C or other conventional fracturing fluid supply system may supply clean fluids substantially free of proppant particles, slurried fluids comprising sand proppant particulates, slurried fluids comprising lightweight proppant particulates, or combinations thereof to the single point fracturing system 170 for injection into the subsurface formation 192 through the fracturing fluid port 180 of a designated sleeve.

Referring to FIG. 3A, a fracturing fluid supply system 300A configured to supply three different fracturing fluids to one or more wells is shown. The fracturing fluid supply system 300A includes four groups of pumps arranged on left and right sides of the system. A first pump group on the right side comprises a pump 302A-1, a pump 302A-2, and a pump 302A-3. A second pump group on the right side comprises a pump 302B-1, a pump 302B-2, and a pump 302B-3. A third pump group on the left side comprises a pump 302C-1, a pump 302C-2, and a pump 302C-3. A fourth pump group on the left side comprises a pump 302D-1, a pump 302D-2, and a pump 302D-3. Each pump is connected to fluid supply conduits via piping 308.

The fracturing fluid supply system 300A includes three fluid sources. A LWP blender 304A is positioned at a bottom left portion of the fracturing fluid supply system 300A and supplies a third fracturing fluid comprising lightweight proppant (“LWP”) particulates to a third fluid cycling conduit 306A. A dirty blender 304B is positioned at a bottom center portion of the fracturing fluid supply system 300A and supplies a second fracturing fluid comprising sand proppant particulates to a second fluid cycling conduit 306B. A clean boost tank 304C is positioned at a center portion of the fracturing fluid supply system 300A and supplies a first fracturing fluid to a first fluid cycling conduit 306C. In some cases, the first fracturing fluid may be substantially free of proppant particles. In some cases, the first fracturing fluid may include water, produced water, treated produced water, slickwater, or combinations thereof. In some cases, the first fracturing fluid may include additives such as a biocide, a scale inhibitor, a viscosity modifier, a friction reducer, or combinations thereof.

With continued reference to FIG. 3A, the LWP blender 304A includes a pump 305A, and the dirty blender 304B includes a pump 305B for supplying the respective fluids into the respective fluid cycling conduits. The third fluid cycling conduit 306A forms an outermost loop connecting to the LWP blender 304A. The second fluid cycling conduit 306B forms a middle loop connecting to the dirty blender 304B. The first fluid cycling conduit 306C forms an innermost loop connecting to the clean boost tank 304C. Each of the third fluid cycling conduit 306A, the second fluid cycling conduit 306B, and the first fluid cycling conduit 306C is fluidly connected with the pump groups 302A, 302B, 302C, and 302D via the piping 308.

As further shown in FIG. 3A, the fracturing fluid supply system 300A includes instrumentation for monitoring fluid properties. An input densometer 310A is associated with the third fluid cycling conduit 306A and is located in proximity to a fluid inlet of the LWP blender 304A to measure a density of fluids returning to the LWP blender 304A. An input densometer 310B is associated with the second fluid cycling conduit 306B and is located in proximity to a fluid inlet of the dirty blender 304B to measure a density of fluids returning to the dirty blender 304B. An output densometer 312A is associated with the third fluid cycling conduit 306A and is located in proximity to a fluid outlet of the LWP blender 304A to measure a density of fluids entering the third fluid cycling conduit 306A. An output densometer 312B is associated with the second fluid cycling conduit 306B and is located in proximity to a fluid outlet of the dirty blender 304B to measure a density of fluids entering the second fluid cycling conduit 306B.

Referring to FIG. 3A, the fracturing fluid supply system 300A further includes a pressure regulator 313A positioned upstream of the input densometer 310A and downstream of the piping 308 from the fourth pump group. A pressure regulator 313B is positioned upstream of the input densometer 310B and downstream of the piping 308 from the fourth pump group. The pressure regulator 313A and the pressure regulator 313B may maintain pressures in the fluid cycling conduits within desirable ranges to feed a suction side of each of the pump groups 302A, 302B, 302C, and 302D. In some cases, the pressure regulator 313A and the pressure regulator 313B may be choke valves. In some cases, the pressure regulator 313A and the pressure regulator 313B may be adjustable choke valves that open and close based on a feedback loop of an automation system controlled by a controller.

With continued reference to FIG. 3A, the fluid cycling conduits 306A, 306B, and 306C may continuously supply each of the different fluids on a low-pressure side of the fracturing fluid supply system 300A to feed pump inlets of the pumps in the pump groups 302A, 302B, 302C, and 302D through valves. In some cases, the valves may be remotely switchable valves. The continuous flow of fluids comprising proppant particles may maintain a substantially homogeneous distribution of proppant particles in the fracturing fluids along a length of the fluid cycling conduits, preventing the proppant particles from settling out and clogging the conduits, valves, and meters.

As further shown in FIG. 3A, the measured densities by the input densometer 310A, the input densometer 310B, the output densometer 312A, and the output densometer 312B may be used by a controller to control an amount and/or a flow rate of various materials to be supplied into the LWP blender 304A and the dirty blender 304B. In some cases, the LWP blender 304A or the dirty blender 304B may mix a slurry to a pre-prescribed density as designed. In some cases, the pre-prescribed density may follow a continuous concentration principle. Based on readings from the input densometer 310A and the input densometer 310B, a supply of proppant particles and/or precursor fluids to the LWP blender 304A and the dirty blender 304B may be adjusted to ensure that a density of the fluid at a blender outlet stays substantially constant.

Referring to FIG. 3B, a fracturing fluid supply system 300B configured to supply fracturing fluids to one or more wells is shown. The fracturing fluid supply system 300B includes four groups of pumps arranged on left and right sides of the system. A first pump group on the right side comprises a pump 302A-1 and a pump 302A-3. A second pump group on the right side comprises a pump 302B-1, a pump 302B-2, and a pump 302B-3. A third pump group on the left side comprises a pump 302C-1, a pump 302C-2, and a pump 302C-3. A fourth pump group on the left side comprises a pump 302D-1, a pump 302D-2, and a pump 302D-3. Each pump is connected to fluid supply conduits via piping 308.

With continued reference to FIG. 3B, the fracturing fluid supply system 300B includes a first fluid supply subsystem comprising a first fluid supply conduit 306D positioned in a center portion of the fracturing fluid supply system 300B. The first fluid supply conduit 306D is fluidly connected with the piping 308 to supply a first fluid to the pump groups. In some cases, the first fluid from the first fluid supply conduit 306D may be substantially free of proppant particles.

As further shown in FIG. 3B, the fracturing fluid supply system 300B further includes a second fluid supply subsystem comprising a second fluid source 304E positioned at a bottom portion of the fracturing fluid supply system 300B. The second fluid source 304E is in fluid communication with a second fluid cycling conduit 306E via a second fluid inlet 314E and a second fluid outlet 316E. The second fluid inlet 314E and the second fluid outlet 316E are in fluid communication with the second fluid cycling conduit 306E forming a second fluid supply loop. The second fluid outlet 316E is configured to supply a second fluid to the second fluid cycling conduit 306E. The second fluid inlet 314E is configured to receive a returning second fluid from the second fluid cycling conduit 306E.

Referring to FIG. 3B, the fracturing fluid supply system 300B includes instrumentation for monitoring fluid properties. A first density meter 310E is associated with the second fluid cycling conduit 306E and is located in proximity to the second fluid inlet 314E to measure a density or flow rate of the returning second fluid entering the second fluid inlet 314E. A flow meter 318E is positioned upstream of the first density meter 310E to measure a flow rate of the returning second fluid. A second density meter 312E is associated with the second fluid cycling conduit 306E and is located in proximity to the second fluid outlet 316E to measure a density or flow rate of the second fluid exiting the second fluid outlet 316E. A flow rate meter 320E is positioned upstream of the second density meter 312E to measure a flow rate of the second fluid exiting the second fluid outlet 316E.

With continued reference to FIG. 3B, the second fluid source 304E is connected to an external slurry source 322E via a precursor second fluid inlet 324E. The external slurry source 322E may supply a precursor second fluid to the second fluid source 304E. In some cases, the precursor second fluid may be a slurry received from the external slurry source 322E. In some cases, the precursor second fluid may be a carrier fluid such as water, produced water, treated produced water, slickwater, with or without additional additives such as a scale inhibitor, a viscosity modifier, a biocide, a friction reducer, or combinations thereof. The second fluid source 304E may comprise a vessel configured to receive the precursor second fluid and blend materials to form a second fluid with a desirable composition and proppant particle distribution exiting the second fluid outlet 316E. In some cases, the second fluid source 304E may comprise a vessel and a stirrer inside the vessel, which during operation agitates materials inside the vessel to obtain a second fluid with a desirable composition and a substantially homogeneous distribution of proppant particles.

Referring to FIG. 3C, a fracturing fluid supply system 300C configured to supply two different fracturing fluids to one or more wells is shown. The fracturing fluid supply system 300C includes four groups of pumps arranged on left and right sides of the system. A first pump group on the right side comprises a pump 302A-1, a pump 302A-2, and a pump 302A-3. A second pump group on the right side comprises a pump 302B-1, a pump 302B-2, and a pump 302B-3. A third pump group on the left side comprises a pump 302C-1, a pump 302C-2, and a pump 302C-3. A fourth pump group on the left side comprises a pump 302D-1, a pump 302D-2, and a pump 302D-3. Each pump is connected to fluid supply conduits via piping 308.

With continued reference to FIG. 3C, the fracturing fluid supply system 300C includes a first fluid supply subsystem comprising a first fluid source 304F positioned at a bottom left portion of the fracturing fluid supply system 300C. The first fluid source 304F is in fluid communication with a first fluid cycling conduit 306F via a first fluid inlet 314F and a first fluid outlet 316F. The first fluid inlet 314F and the first fluid outlet 316F are in fluid communication with the first fluid cycling conduit 306F forming a first fluid supply loop. The first fluid outlet 316F is configured to supply a first fluid to the first fluid cycling conduit 306F. The first fluid inlet 314F is configured to receive a returning first fluid from the first fluid cycling conduit 306F. The first fluid source 304F receives makeup first fluid 322F via a precursor first fluid inlet 324F.

As further shown in FIG. 3C, the fracturing fluid supply system 300C further includes a second fluid supply subsystem comprising a second fluid source 304E positioned at a bottom center portion of the fracturing fluid supply system 300C. The second fluid source 304E is in fluid communication with a second fluid cycling conduit 306E via a second fluid inlet 314E and a second fluid outlet 316E. The second fluid inlet 314E and the second fluid outlet 316E are in fluid communication with the second fluid cycling conduit 306E forming a second fluid supply loop. The second fluid outlet 316E is configured to supply a second fluid to the second fluid cycling conduit 306E. The second fluid inlet 314E is configured to receive a returning second fluid from the second fluid cycling conduit 306E. The second fluid source 304E is connected to an external slurry source 322E via a precursor second fluid inlet 324E.

Referring to FIG. 3C, the fracturing fluid supply system 300C includes instrumentation for monitoring fluid properties. A first density meter 310E is associated with the second fluid cycling conduit 306E and is located in proximity to the second fluid inlet 314E to measure a density or flow rate of the returning second fluid entering the second fluid inlet 314E. A flow meter 318E is positioned to measure a flow rate of the returning second fluid. A second density meter 312E is associated with the second fluid cycling conduit 306E and is located in proximity to the second fluid outlet 316E to measure a density or flow rate of the second fluid exiting the second fluid outlet 316E. A flow rate meter 320E is positioned to measure a flow rate of the second fluid exiting the second fluid outlet 316E. A flow rate meter 320F is associated with the first fluid cycling conduit 306F.

With continued reference to FIG. 3C, the fracturing fluid supply system 300C includes valves 326 positioned at the piping 308 between the pump groups and the first fluid cycling conduit 306F and the second fluid cycling conduit 306E. The second fluid cycling conduit 306E is fluidly connected with each of the valves 326 for the second fluid. The first fluid cycling conduit 306F is fluidly connected with each of the valves 326 for the first fluid. The valves 326 are switchable between an open position and a closed position to selectively supply the fracturing fluids to pump inlets of designated pumps.

As further shown in FIG. 3C, a fluid cycling conduit 328E extends from the second fluid cycling conduit 306E and connects to the pump groups via the piping 308. A fluid cycling conduit 328F extends from the first fluid cycling conduit 306F and connects to the pump groups via the piping 308. The fluid cycling conduit 328E and the fluid cycling conduit 328F provide fluid communication pathways between the respective fluid sources and the pump groups for supplying fracturing fluids to one or more wells.

Referring to FIG. 4A, a pipe-valve system 400A connecting a first fluid supply conduit 406, a second fluid cycling conduit 402, and a third fluid cycling conduit 404 to a pump inlet 414 of a pump supplying fracturing fluid to a designated well is shown. The first fluid supply conduit 406 may supply a first fluid that is substantially free of proppant particles. The second fluid cycling conduit 402 may supply a second fluid comprising sand proppant particulates. The third fluid cycling conduit 404 may supply a third fluid comprising lightweight proppant particulates.

With continued reference to FIG. 4A, the pipe-valve system 400A includes the second fluid cycling conduit 402 positioned at a top portion of the pipe-valve system 400A, the third fluid cycling conduit 404 positioned in a middle portion, and the first fluid supply conduit 406 positioned at a bottom portion. The pump inlet 414 is fluidly connected via a valve 408 to a common supply pipe 407 which splits into two branch pipes. A branch pipe 407A extends from the common supply pipe 407 and is connected to a pipe 410A and a pipe 410C. A branch pipe 407B extends from the common supply pipe 407 and is connected to a pipe 410B and a pipe 410D.

As further shown in FIG. 4A, the branch pipe 407A is fluidly connected to the second fluid cycling conduit 402 via a dirty loop valve 412A and the pipe 410A. The branch pipe 407A is also fluidly connected to the first fluid supply conduit 406 via a dirty purge valve 412C and the pipe 410C. The branch pipe 407B is fluidly connected to the third fluid cycling conduit 404 via a LWP loop valve 412B and the pipe 410B. The branch pipe 407B is also fluidly connected to the first fluid supply conduit 406 via a clean loop valve 412D and the pipe 410D.

Referring to FIG. 4A, the dirty loop valve 412A, the LWP loop valve 412B, the dirty purge valve 412C, and the clean loop valve 412D are each switchable between an open position and a closed position. The dirty loop valve 412A is positioned in close proximity to the second fluid cycling conduit 402. The LWP loop valve 412B is positioned in close proximity to the third fluid cycling conduit 404. The dirty purge valve 412C is positioned in close proximity to the branch pipe 407A. The clean loop valve 412D is positioned in close proximity to the branch pipe 407B.

With continued reference to FIG. 4A, the valve 408 is positioned between the common supply pipe 407 and the pump inlet 414. When the valve 408 is closed, none of the first fluid, the second fluid, and the third fluid is supplied to the pump inlet 414. The arrangement of the dirty loop valve 412A and the LWP loop valve 412B in close proximity to the second fluid cycling conduit 402 and the third fluid cycling conduit 404 respectively may prevent significant settling of proppant particles immediately upstream of the dirty loop valve 412A and the LWP loop valve 412B. The positioning of the dirty purge valve 412C and the clean loop valve 412D in close proximity to the branch pipe 407A and the branch pipe 407B respectively may reduce proppant particle buildup at an end of the pipe 410C and the pipe 410D downstream of the dirty purge valve 412C and the clean loop valve 412D.

Referring to FIG. 4B, a pipe-valve system 400B connecting a first fluid supply conduit 406, a second fluid cycling conduit 402, and a third fluid cycling conduit 404 to a pump inlet 414B of a pump supplying fracturing fluid to a designated well is shown. The pipe-valve system 400B includes the second fluid cycling conduit 402 positioned at a top portion of the pipe-valve system 400B, the third fluid cycling conduit 404 positioned in a middle portion, and the first fluid supply conduit 406 positioned at a bottom portion.

With continued reference to FIG. 4B, the pump inlet 414B is fluidly connected via a valve 408 to a common supply pipe 407 which splits into two branch pipes. A branch pipe 407A extends from the common supply pipe 407 and is connected to a pipe 410A. A branch pipe 407B extends from the common supply pipe 407 and is connected to a pipe 410B.

As further shown in FIG. 4B, the pipe-valve system 400B includes a T-valve 415A positioned at a junction between the second fluid cycling conduit 402, the first fluid supply conduit 406, and the branch pipe 407A. The T-valve 415A receives a first fluid from the first fluid supply conduit 406 and a second fluid from the second fluid cycling conduit 402 through two separate inlets. The T-valve 415A is connected to the branch pipe 407A via the pipe 410A. The T-valve 415A may be adjusted to allow only the first fluid, only the second fluid, both the first fluid and the second fluid, or neither of the first fluid and the second fluid to enter the branch pipe 407A.

Referring to FIG. 4B, the pipe-valve system 400B further includes a T-valve 415B positioned at a junction between the third fluid cycling conduit 404, the first fluid supply conduit 406, and the branch pipe 407B. The T-valve 415B receives the first fluid from the first fluid supply conduit 406 and a third fluid from the third fluid cycling conduit 404 through two separate inlets. The T-valve 415B is connected to the branch pipe 407B via the pipe 410B. The T-valve 415B may be adjusted to allow only the first fluid, only the third fluid, both the first fluid and the third fluid, or neither of the first fluid and the third fluid to enter the branch pipe 407B.

With continued reference to FIG. 4B, the valve 408 is positioned between the common supply pipe 407 and the pump inlet 414B. When the valve 408 is closed, none of the first fluid, the second fluid, and the third fluid is supplied to the pump inlet 414B. Compared to configurations using separate valves, the pipe-valve system 400B uses fewer valves by incorporating the T-valve 415A and the T-valve 415B, which may reduce a number of operations and may improve reliability.

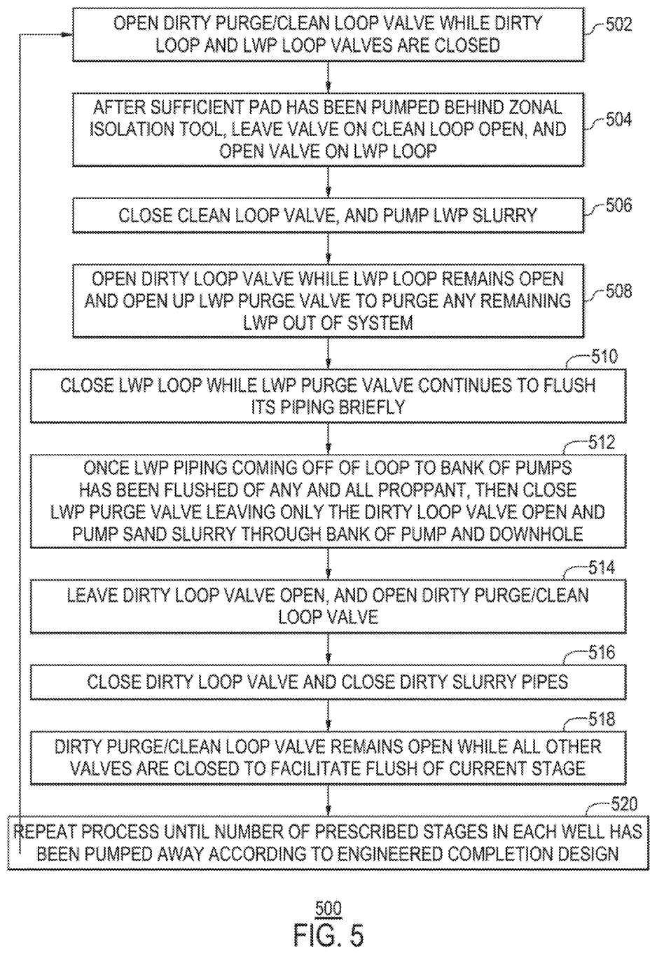

FIG. 5 is a process flow diagram illustrating an exemplary process 500 for pumping hydraulic fracturing fluids to a designated well using the system of FIG. 3A to effect fracturing of a given stage of a designated well. The exemplary process 500 starts at block 502, where a dirty purge/Clean Loop valve 412C and/or 412D is open while the dirty loop valve 412A and LWP loop valve 412B are closed. In various embodiments, this is when the flush from the previous stage takes place, the zonal isolation tool is launched, and the first fluid (“pad fluid”) essentially free of proppant particles for current stage gets pumped behind the zonal isolation tool.

At block 504, after sufficient pad fluid supplied from the first fluid supply conduit 306 has been pumped behind the zonal isolation tool, the transition to the LWP loop takes place. The valve on the clean loop 412C and/or 412D remains open, and the valve 412B connected with the LWP loop is opened as well. This block allows the process to maintain a prime on the pumps and continue operations during the transition from pad fluid to the second fluid comprising LWP particles (“LWP slurry”). At block 506, once the LWP loop valve 412B is opened, then the clean loop valve 412C and 412D are closed. The pre-prescribed quantity of LWP slurry can then be pumped behind the pad fluid as designed. At block 508, a transition is made to the dirty loop, or sand loop. In this transition, the dirty loop valve 412A is opened up to let in the third fluid comprising sand proppant particles (“sand slurry” or “dirty slurry”) while the LWP loop valve 412B remains open. In various embodiments, the LWP purge valve 412D is also opened up to purge any remaining LWP particles out of the system to prevent settling and packing off. In some embodiments, this purge volume can be pre-calculated preferably at a minimum as the displacement volume from the loop to the outlet side of each pump group.

At block 510, once the dirty loop valve 412A has fully opened, then the LWP loop valve 412B is closed while the LWP purge valve 412D continues to flush its piping 307B briefly. At block 512, once the LWP piping 307B has been flushed of any and all proppant, then the LWP purge valve 412D is closed, leaving only the dirty loop valve 412A open. The sand slurry (i.e., the second fluid) is then pumped through the pump group and downhole. The dirty loop valve 412A remains open until the pre-designed volume of sand/dirty slurry has been pumped. At block 514, once the dirty slurry has been pumped to design amount, then it is time for the transition to flush. To transition to flush the dirty loop valve 412A remains open, and the dirty purge/clean loop valve 412C is opened up. At block 516, once the dirty purge/clean loop valve 412C has opened fully, then the dirty loop valve 412A is closed. At this point of the process 500, all pipings feeding dirty slurry to the pump groups downstream of the dirty loop valve 412A gets flushed to prevent sand from accumulating and packing off piping. At block 518, the dirty purge/clean loop valve 412C remains open while all other valves are closed to facilitate the flush of the current stage, the launch of the next zonal isolation tool, and the pad fluid for the next upcoming stage. At block 520, the process 500 is repeated until the number of prescribed stages in each well has been pumped away according to the engineered completion design. The process 500 may be modified in various manner, e.g., by using the system of 300B illustrated in FIG. 3B, by adding an additional fourth fluid cycling conduit supplying a fourth fracturing fluid differing from the first, second, and third fluids as described above, to suit the needs of one or more of the multiple wells.

In various embodiments, the process 500 and variations thereof can be implemented on two or more wells at the same time, in a synchronized manner or preferably in a non-synchronized matter. The various fracturing fluids are continuously supplied to the multiple wells with sufficient flow rates, pressure, and quality. This enables implementing the fracturing operations to multiple wells in a non-synchronized manner. Thus, the valves connecting each fluid supply line/loop for each well/pump group allows for control and manipulation so that each well can essentially be treated independently and not have to rely on any of the other wells being at the exact same point of the pump schedule for each stage. The process and system thus allow for different pump schedules and designs for each individual well so that the designs are customized and more refined for rock qualities of each well, location in the cube/offset wells, and other variables impacting design parameters. By using the controllers, preferably automated controllers, as described above, the fracturing operations of multiple wells can be controlled and adjusted to maximize efficiency and economy of the groups of pumps, and reliability of the overall system and process.

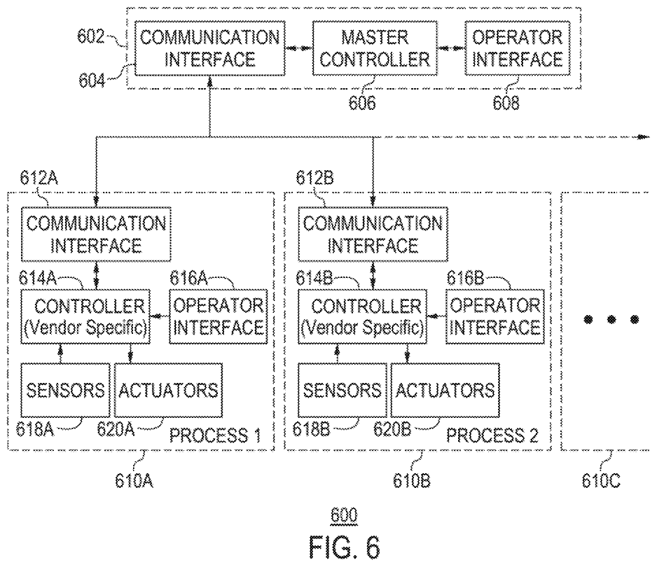

FIG. 6 is a block diagram of an example system 600 with a controller 602 that may control the operation of hydraulic fracturing operations of multiple wells, in accordance with various embodiments of this disclosure. The controller 602 includes a communication interface 604, a master controller 606, and an operator interface 608. In various embodiments, the master controller 606 can control various automated processes. For example, the communication interface 604 may be used to automatically interact with communication interfaces of other subsystems described below. The operator interface 608 may be used to communicate with operators in order to manually adjust one or more parameters of various processes.

The system 600 can include a valving subsystem 610A communicatively coupled to the controller 602. The valving subsystem 610A may be used to control the operation of a hydraulic fracturing operation by actuating valves such as the top valves 148 (FIG. 1) and the bottom valves 150 (FIG. 1). The valving subsystem 610A can include a communication interface 612A communicatively coupled to the communication interface 604 of the controller 602. The valving subsystem 610A can include a controller 614A (which may be vendor-specific) communicatively coupled to the communication interface 612A. The valving subsystem 610A can also include an operator interface 616A communicatively coupled to the controller 614A. The valving subsystem 610A can include a number of sensors 618A and actuators 620A. In various embodiments, the controller 602 may be used to control sequencing of various valves in the system 600 via the actuators 620A. In various embodiments, the sensors 618A may include any number of densometers, pressure sensors, flow rate meters, weight meters, and the like.

The system 600 can include a fracture fluid pumping subsystem 610B communicatively coupled to the controller 602. The fracture fluid pumping subsystem 610B can include a communication interface 612B communicatively similarly coupled to the communication interface 604 of controller 602. The fracture fluid pumping subsystem 610B can also similarly include similarly coupled controller 614B, operator interface 616B, sensors 618B, and actuators 620B.

In various embodiments, the system 600 can include any number of additional subsystems 610C communicatively coupled to the controller 602. For example, the subsystems 610C may be configured to automate any number of additional processes and/or subsystems and equipment.

In various embodiments, the controller 602 can control a system 600 of valving and automation can be used to pull off different streams on the fly throughout a hydraulic fracturing stage. In some embodiments, a manifold of valves setup directly off to the side of missile skids can be used to control and deliver the individual streams of fluid. These valves can be tied into the automation so that they can actuate in the correct sequence for each individual fracturing stage. As the loops continuously circulate, the valves can open and close so that the flow can be manipulated and controlled based upon what fluid each well or pump group needs at that specific time. The valving can allow for one stream or even multiple streams of fluid to flow into a pump group depending on the configuration of the valves open and close status. The configuration of these valves at any given time can be controlled by the automation that is being fed out to the valves from the controller 602 based on the inputs on the engineering design and pump schedule. Several valves can be involved in the proper coordination of the system 600 where isolation devices 162 are deployed into production casing string 116 to engage with and open sleeves 154, 156, as described herein to perform a hydraulic fracturing operation.

In various embodiments, automation technology of the controller 602 can thus be integrated with wellhead valve automation 610A and autonomous fracturing technology 610B, among other technology, to create an integrated software-driven system 600. The automation can feed these actuations through various stages for each of multiple wells simultaneously.

Valve automation and control systems like the control system 600 may be used to control at least one surface processes. A first process may include automation to control low-pressure fluid mixture, flow, and routing of different fracturing fluids and slurries to the suction side of the high-pressure pumps 140. A second process may include automation to control the high-pressure fluid flow and routing from the discharge of pumps 140 to wellheads 144. A third process may include valve automation to control the loading of and subsequent pumping of mobile isolation (activation) devices into the wellbore. The wellhead automation may be controlled via the control system 600 and the low- and high-pressure flow systems are an additional layer that can be included, if desirable. Integration of these processes may be accomplished via the control system 600.

During hydraulic fracturing operations, information may be gathered from the formation 108 in a number of ways. That information may allow the operator within the mobile command center 146 to cause changes to the fracturing operation as it progresses.

This method of hydraulic fracturing allows for a plurality of wells to be stimulated simultaneously and continuously without the need of wireline, E-line, slickline, or coiled tubing for installing plugs and perforating between pumping stages. Once pumping/stimulation begins on a well, it can continue until the entire well has been completed, for example, under control of the control system 600.

Referring to FIGS. 7A and 7B, cross-sectional views of a sleeve assembly in two different operational states are shown. FIG. 7A depicts a closed sleeve 154 configuration, and FIG. 7B depicts an open sleeve 154 configuration. Both views are oriented with a downhole direction indicated by an arrow pointing to the right. In FIG. 7A, the closed sleeve 154 includes a closed inner sleeve 710 positioned within the sleeve assembly. The closed inner sleeve 710 is shown in a first position where fracturing ports 704 are blocked or covered, preventing fluid communication between an interior of the production casing string and a surrounding reservoir. The fracturing ports 704 are visible as openings in an outer wall of the sleeve assembly, but in the closed configuration, the closed inner sleeve 710 obstructs the fracturing ports 704. The closed sleeve 154 includes a sleeve shoulder 702 positioned at multiple locations along the closed sleeve 154. The sleeve shoulder 702 provides engagement surfaces for the isolation device 162 when the isolation device 162 is activated and travels through the wellbore 104 to reach a target sleeve.

With reference to FIG. 7B, the open sleeve 154 is depicted after actuation has occurred. An open inner sleeve 710 has shifted from the first position to a second position, thereby exposing the fracturing ports 704. In the open configuration, the fracturing ports 704 provide fluid communication pathways that allow fracturing fluid to exit the production casing string and enter an adjacent reservoir formation. The open inner sleeve 710 is shown displaced relative to the position of the closed inner sleeve 710 in FIG. 7A, creating exposed flow paths through the fracturing ports 704. The transition from the closed sleeve 154 to the open sleeve 154 occurs when the isolation device 162 engages with the sleeve shoulder 702 and pressurized fluid pushes the isolation device 162 and the inner sleeve 710 combination. The movement of the inner sleeve 710 from the first position to the second position causes the fracture port cover to shift and expose the fracture ports 704. As further shown in FIGS. 7A and 7B, the sleeve assembly structure includes an outer housing with internal features designed to accommodate movement of the inner sleeve between the closed and open positions. The fracturing ports 704 are arranged along the sleeve assembly and become functional conduits for fracturing fluid injection when the inner sleeve shifts to the open position. In some cases, each sleeve may include 2, 3, 4, 5, 6, 7, 8, 9, 10, or more fracturing ports 704. In some cases, the fracturing ports 704 on a designated sleeve may have substantially uniform dimensions and shapes.

Referring to FIGS. 7C and 7D, cross-sectional views of the closed sleeve 154 and the open sleeve 154 are shown with an activated isolation device 162 engaged with the sleeve assembly. Both views are oriented with an arrow indicating the downhole direction. FIG. 7C depicts the closed sleeve 154 in a cross-sectional view. The closed sleeve 154 includes the closed inner sleeve 710 positioned within the sleeve body. Fracturing ports 704 are visible on both upper and lower portions of the sleeve assembly. In the closed configuration, the closed inner sleeve 710 is positioned such that the fracturing ports 704 are blocked, preventing fluid communication between the interior of the production casing string and the surrounding reservoir. The activated isolation device 162 is shown engaged with the closed sleeve 154, positioned within the sleeve structure.

In FIG. 7D, the open sleeve 154 is depicted in a cross-sectional view. Again, the opening of the sleeve 154 occurs when the isolation device 162 engages with the sleeve shoulder 702 and pressurized fluid pushes the isolation device 162 and the inner sleeve 710 combination. The movement of the inner sleeve 710 from the first position to the second position causes a fracture port cover to shift and expose the fracture ports 704. The open sleeve 154 includes the open inner sleeve 710 that has shifted position relative to the closed configuration shown in FIG. 7C. The activated isolation device 162 remains engaged with the sleeve structure. In the open configuration, the open inner sleeve 710 has moved to expose the fracturing ports 704, establishing fluid communication between the interior of the production casing string and the surrounding formation. The fracturing ports 704 are aligned to permit fracturing fluid to exit the production casing string and enter the reservoir for hydraulic fracturing operations.

As further shown in FIGS. 7C and 7D, the transition from the closed sleeve 154 configuration to the open sleeve 154 configuration occurs when the activated isolation device 162 engages with the designated sleeve, causing the inner sleeve to shift from the closed inner sleeve 710 position to the open inner sleeve 710 position. The shifting action may occur due to continued force exerted on the activated isolation device 162 by fluid behind the activated isolation device 162. The shifting action exposes the fracturing ports 704, allowing fracturing fluid to be injected into the subsurface formation while the activated isolation device 162 isolates the open sleeve 154 from the production casing string downhole of the open sleeve 154. It will be understood that the example sleeve 154 and isolation device 162 shown in FIGS. 7A-7D are for illustration purposes only, and the present disclosure is not limited to any specific sleeve or isolation device. FIGS. 7A-7D are nonetheless helpful to show the interplay between an isolation device 162 and a landing profile, e.g., sleeve shoulder 702.

### The Methods and Systems of this Disclosure

The methods and systems of this disclosure relate to performing hydraulic fracturing operations using fracturing fluids comprising lightweight proppant (LWP) particles, including but not limited to single point fracturing. Single point fracturing refers to a hydraulic fracturing technique in which fracturing fluid is pumped through a single cluster of injection ports at a time or in a stage, rather than through multiple clusters simultaneously as in conventional multi-cluster plug-and-perforate operations. The combination of single point fracturing with LWP particles can enable the creation of conductive fractures that are larger and more uniform than would be achievable with either technology alone.

In single point fracturing operations, all pumping capacity can be directed through a single open sleeve or a single cluster of injection ports at any given time. This approach can result in higher fluid velocities through the injection ports compared to multi-cluster operations where the same pumping capacity is divided among multiple clusters. The higher fluid velocities can transport proppant particles farther into the fracture network, potentially resulting in larger propped fracture areas. However, even at elevated velocities, proppant transport can be limited by particle settling, particularly for conventional high-density proppants such as sand.

LWP particles, having apparent densities lower than conventional sand proppants, can exhibit reduced settling tendencies in fracturing fluids. This reduced settling tendency can allow LWP particles to be transported higher vertically and farther laterally into hydraulic fractures compared to sand proppants of similar particle sizes. When combined with the higher fluid velocities achievable through single point fracturing, LWP particles can enable propping of a larger percentage of the overall hydraulic fracture area and at greater distances from the wellbore than would be possible with either single point fracturing or LWP particles alone.

The methods and systems of this disclosure can also provide reduced erosion of downhole hardware components during hydraulic fracturing operations. In fracturing systems, components therein such as fracturing sleeves, instrumentation housings, and associated hardware components can be exposed to various amounts up to the full volume of proppant-laden fracturing fluid pumped during the fracturing operation of the entire well. Components such as sleeves positioned closer to the heel of a lateral wellbore can be subjected to proppant flow from all subsequent fracturing stages, resulting in cumulative erosion exposure. Landing profiles, shoulders, and other features on the sleeves and instrumentation housing that extend into the flow path of the fracturing fluid or otherwise contact the fracturing fluid can be particularly susceptible to erosion.

LWP particles can exhibit lower erosion potential compared to conventional sand proppants due to several characteristics. LWP particles can have lower apparent densities than sand, which can result in reduced momentum transfer upon contact with hardware surfaces. LWP particles can also have lower hardness values than sand particles, which can reduce abrasive wear on contacted surfaces. Additionally, LWP particles can have smaller median particle sizes (D50) than typical sand proppants, and smaller particles can tend to follow fluid flow streamlines more closely rather than deviating to impact hardware surfaces. The combination of lower density, lower hardness, and smaller particle sizes can result in reduced erosion of sleeve components such as landing profiles, shoulders, and sealing surfaces.

By varying the proppant composition such that fracturing fluids used for stages near the toe can comprise higher concentrations of LWP particles than the fracturing fluids used for stages near the heel, the cumulative erosion experienced by sleeves near the heel can be reduced, because all fracturing fluid pumped for stages near the toe must flow past the sleeves near the heel to reach the toe.

Any suitable fracturing fluid can be used in the methods of this disclosure. In various embodiments, the fracturing fluid comprises a carrier fluid and proppant particles, and the carrier fluid is selected from: (i) a slickwater-based carrier fluid having a viscosity from 1 to 20 centipoise; (ii) a linear-gel-based carrier fluid having a viscosity from 20 to 40 centipoise; and (iii) a crosslinked gel-based carrier fluid having a viscosity from 100 to 500 centipoise. The fracturing fluid may be prepared by a process comprising adjusting the viscosity of the fluid to at least 1 centipoise (e.g., 1, 5, 10, 50, 100, 200, 300, 400, 500 centipoise) to reduce settling velocity of the proppant particles of the fracturing fluid.

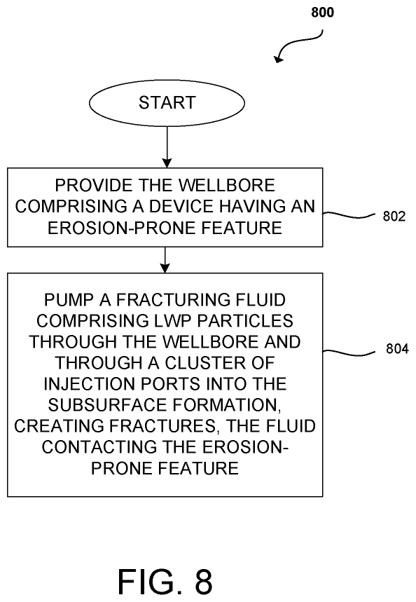

Referring to FIG. 8, a method 800 for performing a hydraulic fracturing operation via a wellbore to a subsurface formation is illustrated. The method 800 begins at a Start and proceeds to a step 802 of providing the wellbore 104, wherein the wellbore 104 comprises a device having an erosion-prone feature during the hydraulic fracturing operation. The device can comprise a fracturing sleeve, such as the sleeve 154 described with reference to FIGS. 7A and 7B. The sleeve 154 can comprise a cluster of injection ports, such as the fracture ports 704. The device can also include an instrumentation housing.

The erosion-prone feature can comprise a protrusion on the fracturing sleeve extending into a flow path of the fracturing fluid in the wellbore 104. In some embodiments, the protrusion can comprise a shoulder, such as the sleeve shoulder 702, and the shoulder can be the erosion-prone feature. The sleeve shoulder 702 can be configured to engage with the isolation device 162 to isolate an uphole portion of the wellbore 104 from a downhole portion of the wellbore 104. As described previously with reference to FIGS. 7A and 7B, the sleeve shoulder 702 provides engagement surfaces for the isolation device 162 and can be subjected to contact with fracturing fluid during the hydraulic fracturing operation.

The sleeve 154 can comprise a landing profile that is subject to cumulative erosion from all fracturing stages pumped through the wellbore 104. For sleeves positioned closer to the heel 124 of the lateral section 122, the landing profile can be exposed to proppant-laden fracturing fluid from hundreds of fracturing stages, resulting in substantial cumulative erosion exposure. In some embodiments, the sleeve 154 can comprise a hard coating on the landing profile to resist erosion. The sleeve 154 can also comprise an ID restriction at the landing seat location, which can create flow disturbances that affect proppant particle trajectories. In some embodiments, the wellbore can comprise a lateral having a toe and a heel. During a total duration of the fracturing operation through a full length of the wellbore, the fracturing fluid used to fracture a stage including the toe can comprise (i) more LWP particles than the fracturing fluid used to fracture a stage including the heel, and (ii) less non-LWP proppant particles than the fracturing fluid used to fracture the stage including the heel. This variation in proppant composition between toe stages and heel stages can be achieved by adjusting the ratio of LWP particles to non-LWP proppant particles in the fracturing fluid as the fracturing operation progresses from the toe toward the heel of the lateral. The higher concentration of LWP particles in fracturing fluids used for toe stages can provide dual benefits. First, the LWP particles can enhance proppant transport into fractures at the toe, where fractures may be farthest from the surface pumping equipment and where maintaining proppant suspension over long transport distances can be beneficial. Second, because all fracturing fluid pumped for stages near the toe must flow past the sleeves near the heel to reach the toe, the higher LWP content in these fluids can reduce the cumulative erosion experienced by heel-proximate sleeve components, including landing profiles and shoulders. The lower concentration of non-LWP proppant particles (e.g., sand) in the toe-stage fracturing fluids means that less abrasive, higher-density material flows past the heel sleeves during these stages, thereby reducing erosion potential at the sleeves at the heel.

With continued reference to FIG. 8, the method 800 proceeds to a step 804 of pumping a fracturing fluid comprising lightweight proppant (LWP) particles through the wellbore 104 and through the cluster of injection ports into the subsurface formation 108, thereby creating a plurality of fractures in the subsurface formation 108. During step 804, the fracturing fluid contacts the erosion-prone feature, such as the sleeve shoulder 702 or the landing profile of the sleeve 154.

The LWP particles can be present in the fracturing fluid at a concentration from 14 kilograms per cubic meter to 480 kilograms per cubic meter, based on a total volume of a carrier fluid. In some embodiments, the fracturing fluid can further comprise non-LWP proppant particles having an apparent density higher than an apparent density of the LWP particles. The non-LWP proppant particles can comprise sand, ceramic proppants, or other conventional proppants having apparent densities higher than 2.2 g/cm³. The LWP particles can have a concentration from 10% to 50% by volume in the fracturing fluid, based on a total volume of all proppant particulates in the fracturing fluid, on a dry particle basis. In some embodiments, the LWP particles can have a concentration from 10% to 33% by volume, based on the total volume of all proppant particulates in the fracturing fluid, on a dry particle basis.

The LWP particles can have a hardness lower than a hardness of the non-LWP proppant particles. The lower hardness of the LWP particles can result in reduced abrasive wear on the erosion-prone feature when the fracturing fluid contacts the sleeve shoulder 702 or other protrusions extending into the flow path. By replacing a portion of the non-LWP proppant particles with LWP particles, the fracturing fluid can exhibit reduced erosion potential while maintaining proppant transport characteristics suitable for creating conductive fractures in the subsurface formation 108.

In some embodiments, step 804 can comprise, in a single fracturing stage, pumping a first fracturing fluid into the subsurface formation via the wellbore, and subsequently pumping a second fracturing fluid differing from the first fracturing fluid into the subsurface formation via the wellbore. At least one of the first fracturing fluid and the second fracturing fluid can comprise LWP particles. In some embodiments, at least one of the first fracturing fluid and the second fracturing fluid can comprise non-LWP proppant particles having an apparent density higher than the apparent density of the LWP particles. The LWP particles can have a hardness lower than a hardness of the non-LWP proppant particles, as described previously. Such sequential injection of differing fracturing fluids comprising differing proppant particles can achieve advantaged transport of LWP particles into distant fractures, enabling high conductivity throughout the subsurface formation and enhanced productivity of desired products such as hydrocarbon molecules.

In some embodiments, one of the first fracturing fluid and the second fracturing fluid can comprise LWP particles and can be free of non-LWP proppant particles, and the other fracturing fluid can comprise non-LWP proppant particles and can be free of LWP particles. In such embodiments, the non-LWP proppant particles can comprise sand, and the LWP particles can comprise coke particles. The coke particles can comprise petroleum coke, such as fluid coke, flexicoke, thermally post-treated delayed coke, or combinations thereof. The LWP particles can constitute from 10% to 75% (e.g., 10%, 15%, 20%, 25%, 30%, 35%, 40%, 45%, 50%, 55%, 60%, 65%, 70%, 75%) by volume of a total volume of all proppant particulates in the first fracturing fluid and the second fracturing fluid, on a dry particle basis. In a preferred embodiment, the first fracturing fluid comprises LWP particles (e.g., coke particles) and the second fracturing fluid comprises non-LWP proppant particles. In a preferred embodiment, the first fracturing fluid can comprise LWP particles (e.g., coke particles) and be free of non-LWP proppant particles, and the second fracturing fluid can comprise non-LWP proppant particles (e.g., sand) and be free of LWP particles.

The LWP particles and non-LWP proppant particles can be pumped as a blended mixture in the fracturing fluid. In such embodiments, the blended mixture can comprise both LWP particles and non-LWP proppant particles dispersed together in a carrier fluid, and the blended mixture can be pumped through the wellbore and through the cluster of injection ports into the subsurface formation.

The method can further comprise replacing a portion of non-LWP proppant particles (e.g., sand proppant particles) with LWP particles to reduce the total mass of non-LWP proppant particles pumped during the fracturing operation. By substituting LWP particles for a portion of the non-LWP proppant particles (e.g., sand proppant particles), the fracturing fluid can exhibit enhanced proppant transport characteristics due to the lower apparent density of the LWP particles, while also reducing the cumulative erosion exposure experienced by downhole hardware components. The reduced mass of sand pumped can result in lower erosion potential at sleeve components positioned near the heel of the wellbore, where cumulative proppant throughput can be highest during multi-stage fracturing operations.

In some embodiments, the fracturing fluid can be pumped simultaneously through no more than three clusters of injection ports in the wellbore at a time. By limiting the number of clusters through which fracturing fluid is pumped simultaneously, the available pumping capacity can be concentrated through fewer injection points, resulting in higher fluid velocities through each cluster and more uniform flow through the limited number of clusters, resulting in higher uniformity of the fractures created at the clusters, compared to conventional hydraulic fracturing using multi-cluster plug and perforate operations. In some embodiments, the fracturing fluid can be pumped through only one cluster of injection ports of a single sleeve in the open position in the wellbore at a time. This single point fracturing approach can direct all available pumping capacity through a single cluster, maximizing fluid velocity through the injection ports, resulting in high uniformity of fractures with long average fracture length. The LWP particles in the fracturing fluid, due to its low apparent density, can be carried further into the long fractures, and be distributed in multiple fractures more uniformly, compared to the conventional fracturing method performed to multiple clusters (more than 3, e.g., 4, 5, 6, 7, 8, 9, 10, or even more) using the plug-and-perf technology. Moreover, due to the lower density and lower hardness of the LWP particles (e.g., coke proppant) compared to non-LWP proppant particles (e.g., sand proppant), the erosion of the wellbore component prone to erosion on contacting such high-velocity proppant particles is also reduced in the methods of this disclosure.

In some embodiments, the one cluster of injection ports can be present on a single fracturing sleeve. When the fracturing fluid is pumped through a single fracturing sleeve at a time, the isolation device engaged with the sleeve can provide isolation of the wellbore such that all fracturing fluid exits through the injection ports of that single sleeve. This configuration can enable precise control over fracture placement and can result in fractures that are more uniform than fractures created by multi-cluster plug and perforate operations, where fracturing fluid is distributed among multiple clusters and individual fractures may receive varying amounts of fluid and proppant.

The fracturing fluid can be pumped into the subsurface formation at a flow rate of at least 30 (e.g., 30, 40, 50, 60, 70, 80, 90, 100) barrels per minute per cluster of injection ports. In some embodiments, the fracturing fluid can be pumped into the subsurface formation at a flow rate of no more than 200 (e.g., 200, 190, 180, 170, 160, 150, 140, 130, 120) barrels per minute per cluster of injection ports. Flow rates within this range can provide sufficient fluid velocity to transport proppant particles deep into the fracture network while remaining within operational limits of surface pumping equipment and downhole hardware components. In single point fracturing operations, the fracturing fluid can be pumped at velocities approximately 10 times higher than conventional multi-cluster plug and perforate operations. The elevated velocities achievable through single point fracturing can transport proppant particles farther into the fracture network before settling occurs, resulting in larger propped fracture areas.

The plurality of fractures created during the hydraulic fracturing operation can have a half-length of at least 200 feet, wherein the half-length is the distance from the wellbore to the tip of one wing of the fracture, otherwise called the “fracture length.” In some embodiments, the plurality of fractures can have a half-length of no more than 4,000 feet. Fracture half-lengths within this range can provide substantial contact area with the reservoir while avoiding undesirable fracture geometries that could result in communication with neighboring wells, depleted zones, or water-bearing intervals. The combination of single point fracturing with LWP particles can enable the creation of fractures at the upper end of this half-length range while maintaining a high ratio of conductive fracture area to total wetted fracture area, as the reduced settling tendency of LWP particles can allow proppant to be transported to greater distances from the wellbore.

The single point fracturing operation can create fractures that are more uniform than fractures created by multi-cluster plug and perforate operations. In conventional multi-cluster operations, fracturing fluid can be distributed unevenly among multiple clusters, resulting in some fractures receiving more fluid and proppant than others. This uneven distribution can result in runaway fractures that extend farther than intended and short fractures that do not adequately contact the reservoir. In single point fracturing, each fracture stage can receive a controlled amount of fracturing fluid and proppant, resulting in fractures of more consistent dimensions. The uniformity of fractures created through single point fracturing can improve reservoir depletion efficiency and can reduce the risk of fracture interference with neighboring wells.

The LWP particles can have an apparent density in a range from 1.0 g/cm³ to 2.0 g/cm³. In some embodiments, the LWP particles can have a specific gravity in a range from 1.5 to 1.7, depending on the source material and processing conditions. The apparent density of the LWP particles can be lower than the apparent density of non-LWP proppant particles, which can result in reduced settling tendencies in fracturing fluids and improved proppant transport into hydraulic fractures.

In some embodiments, at least 50 wt % (e.g., 50%, 55%, 60%, 65%, 70%, 75%, 80%, 85%, 90%, 95%, 100%) of the LWP particles can have particle sizes from 88 μm to 250 μm. The LWP particles can have a mesh size of 60/140 or 60/170, indicating that the particles pass through a 60 mesh screen and are retained on a 140 mesh or 170 mesh screen, respectively. In some embodiments, the LWP particles can have a mesh size with an upper limit of 50 mesh, meaning that particles larger than 50 mesh can be excluded from the LWP particle distribution. The LWP particles can comprise microproppant particles having a mesh size of 140 mesh or smaller, which can penetrate into smaller fracture apertures and microfractures within the subsurface formation.

The LWP particles can have a D50 that is smaller than a D50 of the non-LWP proppant particles. This difference in median particle size can result from the LWP particles being capped at 60 mesh on the upper end of the particle size distribution, while sand proppants can extend to 40 mesh. The non-LWP proppant particles can comprise sand having a mesh size of 40/140, indicating that the sand particles pass through a 40 mesh screen and are retained on a 140 mesh screen. The non-LWP proppant particles can comprise sand having a specific gravity of approximately 2.65, which can be higher than the specific gravity of the LWP particles. The smaller D50 of the LWP particles compared to the non-LWP proppant particles can contribute to improved proppant transport characteristics, as smaller particles can tend to follow fluid flow streamlines more closely and can settle more slowly in fracturing fluids.

The LWP particles can have a sphericity of from 0.4 to 1.0 (e.g., about 0.4, 0.5, 0.6, 0.7, 0.8, 0.9, 1.0). The LWP particles (e.g., those coke proppant particles made by using a fluid process, such as fluid coke and flexicoke) can have a lower angularity than sand particles, being more spherical with small bumps rather than sharp edges. The reduced angularity of the LWP particles can result in lower erosion potential when the particles contact downhole hardware surfaces, as rounded particles can cause less abrasive wear than angular particles with sharp edges. The LWP particles can be softer than steel, which can further reduce erosion of metallic sleeve components and landing profiles during hydraulic fracturing operations.

As described previously, the LWP particles can comprise petroleum coke. The petroleum coke can be selected from (i) fluid coke, (ii) flexicoke, (iii) thermally post-treated delayed coke, and (iv) combinations of two or more of (i), (ii), and (iii). The LWP particles can comprise fluid coke particles that are formed by a fluid coking process and have a lumpy or agglomerated surface texture. The LWP particles can comprise flexicoke particles that are formed by a flexicoking process and have a lumpy or agglomerated surface texture. The lumpy or agglomerated surface texture of fluid coke and flexicoke particles can result from the formation process, where coke deposits in ring-like patterns atop seed coke particles in a fluidized bed reactor. The LWP particles can comprise crushed delayed coke that has been thermally post-treated. Thermally post-treated delayed coke can be produced by crushing delayed coke and heating the crushed material to temperatures in a range from around 400° C. to 1200° C. for a predetermined duration.

In some embodiments, the LWP particles can comprise alternative materials other than petroleum coke. The LWP particles can comprise polystyrene divinyl benzene material having a specific gravity of approximately 1.06. Polystyrene divinyl benzene materials can provide ultra-lightweight proppant characteristics with apparent densities lower than petroleum coke proppants. The LWP particles can comprise lightweight ceramic proppant having a specific gravity of approximately 2.0. Lightweight ceramic proppants can provide intermediate density characteristics between petroleum coke proppants and conventional sand proppants, and can offer different hardness and crush strength properties compared to coke-based proppants.

In some embodiments, the wellbore can comprise a lateral having a toe and a heel, and the fracturing fluid composition can vary along the wellbore during the hydraulic fracturing operation. During a total duration of the fracturing operation through a full length of the wellbore, the fracturing fluid used to fracture a stage including the toe can comprise more LWP particles than the fracturing fluid used to fracture a stage including the heel. Additionally, the fracturing fluid used to fracture the stage including the toe can comprise less non-LWP proppant particles than the fracturing fluid used to fracture the stage including the heel. As used herein, when comparing amounts of proppant particles between fracturing stages or fracturing fluids, the terms “more,” “less,” “increasing amount,” and “decreasing amount” refer to comparisons based on total volume of the respective proppant particles, on a dry particle basis, unless otherwise specified. For example, a fracturing fluid comprising “more LWP particles” than another fracturing fluid means that the first fracturing fluid comprises a greater total volume of LWP particles, on a dry particle basis, than the second fracturing fluid.

In some embodiments, from the stage including the toe to the stage including the heel, the fracturing fluids used can comprise decreasing amounts of LWP particles and increasing amounts of non-LWP proppant particles. This graduated variation in proppant composition along the wellbore can provide benefits related to both proppant transport and erosion mitigation. Stages near the toe can receive fracturing fluids with higher concentrations of LWP particles, which can enhance proppant transport into the fracture network at locations farthest from the wellhead. Stages near the heel can receive fracturing fluids with higher concentrations of non-LWP proppant particles, such as sand, which can provide cost advantages while the sleeves at these locations experience reduced cumulative proppant throughput compared to sleeves near the heel during the overall fracturing operation.

The wellbore can comprise a lateral having a length of 15,000 feet in the pay zone. In some embodiments, the wellbore can comprise a lateral having a length of 20,000 feet in the pay zone. In some embodiments, the wellbore can comprise a lateral having a length of 25,000 feet in the pay zone. Lateral lengths of 20,000 feet and 25,000 feet can represent extended reach wells that can expose sleeves near the heel to substantial cumulative proppant throughput during multi-stage fracturing operations.

The hydraulic fracturing operation can comprise 400 to 500 fracturing stages along the wellbore. For wells with 400 to 500 fracturing stages, sleeves positioned near the heel of the lateral can be exposed to proppant-laden fracturing fluid from all subsequent fracturing stages as the operation progresses from the toe toward the heel. This cumulative erosion exposure can be concentrated at sleeves near the heel, where landing profiles and other erosion-prone features can experience contact with proppant particles from hundreds of fracturing stages.

By varying the proppant composition such that fracturing fluids used for stages near the toe can comprise higher concentrations of LWP particles, the cumulative erosion experienced by sleeves near the heel can be reduced. The lower apparent density, lower hardness, and smaller median particle sizes of LWP particles compared to non-LWP proppant particles can result in reduced erosion potential at the sleeves that experience the highest cumulative proppant throughput during the fracturing operation. This approach can extend the operational life of sleeve components near the heel and can reduce the need for expensive erosion-resistant coatings or hardened materials on these components.

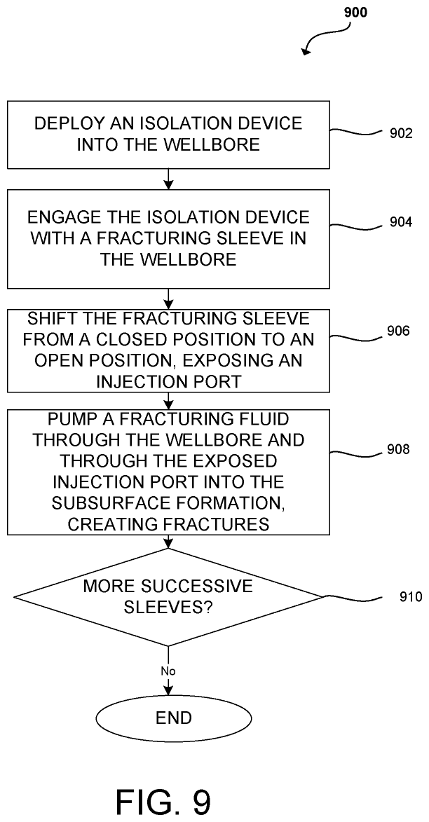

Referring to FIG. 9, a method 900 for performing single point hydraulic fracturing via a wellbore 104 comprising a plurality of fracturing sleeves to a subsurface formation 108 is illustrated. The method 900 begins at a Start and proceeds to a step 902 of deploying an isolation device 162 into the wellbore 104. The isolation device 162 can comprise a dart that expands upon activation before landing on a landing profile of a designated fracturing sleeve. The isolation device 162 can be deployed into the wellbore 104 through the wellhead 144, and can be pumped downhole by the fracturing fluid toward the designated fracturing sleeve.

In some embodiments, the isolation device 162 can comprise a dissolvable material that dissolves after the fracturing operation. The dissolvable material can allow the isolation device 162 to be removed from the wellbore 104 without requiring retrieval operations after the hydraulic fracturing operation is completed. The isolation device 162 can be launched from a pressure equalization chamber at the surface 106, as described previously with reference to FIG. 1, and can travel through the wellbore 104 to reach the designated fracturing sleeve.

The method 900 proceeds to a step 904 of engaging the isolation device 162 with a fracturing sleeve in the wellbore 104. The sleeve 154 can have a shoulder, such as the sleeve shoulder 702 described with reference to FIGS. 7A and 7B, extending into the wellbore 104 for engaging with the isolation device 162. When the isolation device 162 reaches the designated fracturing sleeve, the isolation device 162 can engage with the sleeve shoulder 702 and can form a metal-to-metal seal on a tapered landing profile of the sleeve 154. The tapered landing profile can provide a sealing surface against which the isolation device 162 seats to isolate an uphole portion of the wellbore 104 from a downhole portion of the wellbore 104.

The method 900 proceeds to a step 906 of shifting the fracturing sleeve from a closed position to an open position, thereby exposing an injection port. As described previously with reference to FIGS. 7A and 7B, the isolation device 162 can shift the sleeve 154 from the closed position to the open position by engaging with the sleeve shoulder 702 and applying pressure from the pumping fluid. The inner sleeve 710 can move from a first position to a second position, causing the fracture ports 704 to become exposed. The shoulder contacts the fracturing fluid during the hydraulic fracturing operation and is subjected to erosion, as the fracturing fluid flows past the sleeve shoulder 702 and through the exposed fracture ports 704.

The method 900 proceeds to a step 908 of pumping a fracturing fluid comprising lightweight proppant (LWP) particles through the wellbore 104 and through the exposed injection port into the subsurface formation 108, thereby creating a plurality of fractures in the subsurface formation 108. The fracturing fluid can comprise LWP particles and non-LWP proppant particles as described previously with reference to the method 800 illustrated in FIG. 8. The fracturing fluid can be pumped at flow rates and concentrations as described previously, and the LWP particles can provide reduced erosion potential at the sleeve shoulder 702 or any other erosion-prone features of the sleeve 154. In some cases, during step (D), no more than three of the plurality of the fracturing sleeves are in an open position allowing the fracturing fluid to pass through flow ports therein. In some cases, during step (D), only one of the fracturing sleeves is in the open position allowing the fracturing fluid to pass through flow port therein, which is a type of single point fracturing operation.

With continued reference to FIG. 9, the method 900 can optionally be repeated for successive fracturing sleeves. For example, the steps 902, 904, 906, and 908 can be repeated for each successive fracturing sleeve in the plurality of fracturing sleeves from toe to heel of the wellbore. The isolation device 162 used for the previous fracturing stage can dissolve or be retrieved and/or destroyed at a later time. When no more successive sleeves remain, the method 900 may end.

The sleeve system can comprise an intelligent fracture sleeve system with automation capabilities. The intelligent fracture sleeve system can be controlled by the controller 602 described with reference to FIG. 6, and can provide automated sequencing of sleeve activation and fracturing fluid pumping operations. The sleeve system can comprise an unlimited fracture sleeve system capable of activating any number of sleeves. The unlimited fracture sleeve system can accommodate wells with 400 to 500 or more fracturing stages, as described previously, without limitations on the number of sleeves that can be activated during the hydraulic fracturing operation.

By repeating the step 902, the step 904, the step 906, and the step 908 for successive fracturing sleeves of the plurality of fracturing sleeves, the method 900 can progress from the toe 126 toward the heel 124 of the lateral section 122, activating each sleeve 154 in sequence and creating fractures at each fracturing stage. The cumulative erosion experienced by sleeves positioned closer to the heel 124 can be reduced by the use of fracturing fluids comprising LWP particles, as the lower apparent density, lower hardness, and smaller median particle sizes of the LWP particles can result in reduced erosion potential compared to conventional sand proppants.

In some embodiments of the method 900 for performing hydraulic fracturing, a concentration of lightweight proppant (LWP) in the fracturing fluid can be lower for sleeves located closer to a heel of the wellbore than for sleeves located closer to a toe of the wellbore. This graduated variation in LWP concentration along the wellbore can provide enhanced erosion protection at sleeve locations that experience the highest cumulative proppant throughput during the fracturing operation. Sleeves positioned near the heel can be exposed to proppant-laden fracturing fluid from all subsequent fracturing stages as the operation progresses from the toe toward the heel. Because fracturing fluids used for stages near the toe comprise higher concentrations of LWP particles, and because these fluids must flow past the heel sleeves to reach the toe, the heel sleeves are exposed to fracturing fluids with higher LWP content and lower sand content, thereby reducing the cumulative erosion experienced by the landing profiles and other erosion-prone features of these sleeves.

The fracturing fluid can comprise LWP particles and non-LWP proppant particles, wherein the LWP particles comprise a lower hardness than the non-LWP proppant particles, thereby reducing erosion of landing profiles of the plurality of sleeves during the repeating step of the method 900. The lower hardness of the LWP particles can result in reduced abrasive wear when the fracturing fluid contacts the landing profiles, shoulders, and sealing surfaces of the fracturing sleeves. The non-LWP proppant particles can comprise sand or ceramic proppants having hardness values higher than the LWP particles, and by replacing a portion of these harder non-LWP proppant particles with softer LWP particles, the overall erosion potential of the fracturing fluid can be reduced while maintaining proppant transport and fracture conductivity characteristics.

The fracturing fluid can further comprise non-LWP proppant particles having an apparent density higher than an apparent density of the LWP particles. The LWP particles can have a concentration from 10% to 80% (e.g., 10%, 15%, 20%, 25%, 30%, 35%, 40%, 45%, 50%, 55%, 60%, 65%, 70%, 75%, 80%) by volume in the fracturing fluid, based on a total volume of all proppant particulates in the fracturing fluid, on a dry particle basis. In some embodiments, the LWP particles can have a concentration from 10% to 33% (e.g., 10%, 15%, 20%, 25%, 30%, 33%) by volume, based on the total volume of all proppant particulates in the fracturing fluid, on a dry particle basis. The LWP particles can have a hardness lower than a hardness of the non-LWP proppant particles, as described previously, which can contribute to reduced erosion of sleeve components during the hydraulic fracturing operation.

In some embodiments, the pumping step of the method 900 can comprise, in a single fracturing stage, pumping a first fracturing fluid into the subsurface formation via the wellbore, and subsequently pumping a second fracturing fluid differing from the first fracturing fluid into the subsurface formation via the wellbore. At least one of the first fracturing fluid and the second fracturing fluid can comprise LWP particles. In some embodiments, at least one of the first fracturing fluid and the second fracturing fluid can comprise non-LWP proppant particles having an apparent density higher than the apparent density of the LWP particles. The LWP particles can have a hardness lower than a hardness of the non-LWP proppant particles, which can provide erosion reduction benefits when the fracturing fluids contact the sleeve components during the sequential pumping operations.

The method 900 can create conductive fractures having a ratio of conductive fracture area to wetted fracture area that is higher than achievable with sand proppant alone. The reduced settling tendency of the LWP particles compared to sand proppant can allow the LWP particles to be transported farther into the fracture network, resulting in a larger portion of the wetted fracture area being propped with conductive proppant material. Conventional plug and perf operations using sand proppant can create conductive fractures that prop approximately half the length and half the height of the wetted fracture, leaving substantial portions of the wetted fracture area unpropped and non-conductive after fracture closure.

The method 900 can create conductive fractures that prop a higher percentage of the wetted fracture area than achievable with plug and perf operations using LWP alone. The combination of single point fracturing with LWP particles can provide synergistic benefits, where the higher fluid velocities achievable through single point fracturing can transport the LWP particles to greater distances than achievable with conventional multi-cluster plug and perf operations, and the reduced settling tendency of the LWP particles can allow proppant placement at locations that would be inaccessible to sand proppant even at the elevated velocities of single point fracturing. This combination can enable the creation of conductive fractures that are larger and more uniform than would be achievable with either single point fracturing using sand proppant or plug and perf operations using LWP particles.

In some embodiments, the method can be performed to avoid fracture communication with a parent well. Parent wells are existing production wells that have been previously completed and may be producing hydrocarbons from the same reservoir interval as the well being fractured. Fracture communication with a parent well can result in fluid loss from the fracturing operation into the parent well, reduced fracturing efficiency, and potential damage to the parent well. By controlling fracture growth through single point fracturing techniques and utilizing LWP particles to maximize the ratio of conductive fracture area to wetted fracture area, the method can create fractures that remain contained within a target zone without extending to communicate with neighboring parent wells.

In some embodiments, the method can be performed to avoid fracture communication with a water injection zone. Water injection zones can be present in formations where water has been injected for enhanced oil recovery or disposal purposes, and such zones may contain undesirable fluids such as hydrogen sulfide (H2S) or other contaminants. Fracture communication with a water injection zone can result in influx of injected water or contaminants into the fractured well, reducing hydrocarbon production and potentially creating safety or environmental concerns. The method can be performed to contain fracture growth such that fractures do not extend into water injection zones located above, below, or laterally adjacent to the target reservoir interval.

In some embodiments, the method can be performed to avoid fracture communication with a depleted zone. Depleted zones are reservoir intervals that have been previously produced and have reduced reservoir pressure compared to the target zone being fractured. Fracture communication with a depleted zone can result in fracturing fluid and proppant being lost into the depleted interval rather than being placed in the target zone, reducing fracturing efficiency and potentially creating unproductive fracture connections. The method can be performed to contain fracture growth within the target zone while avoiding communication with depleted zones that may be present below or adjacent to the target interval.

In some embodiments, the method can be performed to avoid fracture communication with a wet zone. Wet zones are reservoir intervals that contain water rather than hydrocarbons, and fracture communication with a wet zone can result in water production from the fractured well. Water production can reduce hydrocarbon recovery efficiency and can create disposal challenges for produced water. The method can be performed to contain fracture growth such that fractures remain within hydrocarbon-bearing intervals and do not extend into water-bearing zones.

In some embodiments, the method can be performed to contain fracture growth within a target zone while maximizing the ratio of conductive fracture area to wetted fracture area. When fracture growth is constrained to avoid communication with parent wells, water injection zones, depleted zones, or wet zones, the wetted fracture area may be limited by the boundaries of the target zone. In such constrained fracturing scenarios, maximizing the ratio of conductive fracture area to wetted fracture area can be beneficial for optimizing hydrocarbon recovery from the available fracture volume. The reduced settling tendency of LWP particles compared to conventional sand proppant can allow a larger portion of the constrained wetted fracture area to be propped with conductive proppant material, resulting in improved fracture conductivity within the target zone boundaries.

In some embodiments, the method can further comprise calibrating fracture models using data collected from the single point fracturing operation with LWP particles. Fracture models can be used to predict fracture geometry, proppant placement, and fracture conductivity for hydraulic fracturing operations. Data collected from single point fracturing operations with LWP particles can be used to calibrate fracture models for improved accuracy in predicting the behavior of LWP particles at the elevated fluid velocities achievable through single point fracturing. Calibrated fracture models can enable interpolation of fracture behavior within the range of conditions represented by the calibration data, providing more reliable predictions than extrapolation from models calibrated using conventional plug and perf operations or sand proppant alone.

In some embodiments, the method can further comprise measuring fracture dimensions using fiber optic cross-well measurements. Fiber optic cross-well measurements can provide direct measurement of fracture geometry, including fracture length, fracture height, and fracture uniformity, by detecting strain or acoustic signals in a monitoring well that is intersected by or in proximity to the created fractures. Fiber optic cross-well measurements can be used to verify that fractures created through single point fracturing with LWP particles achieve the intended dimensions and uniformity, and can provide data for calibrating fracture models as described above.

In some embodiments, the method can further comprise monitoring the fracturing operation using a slant monitoring well that extends away from the wellbore. A slant monitoring well can be drilled at an angle that extends away from the wellbore being fractured, providing measurement locations at varying distances from the fractured well. The slant monitoring well can be equipped with fiber optic sensors or other measurement devices that can detect fracture arrival, fracture dimensions, and fracture conductivity at multiple distances from the fractured well. Data collected from the slant monitoring well can be used to verify proppant transport distances, confirm fracture uniformity, and calibrate fracture models for single point fracturing operations with LWP particles.

In some embodiments, the fracturing operation can be performed on a well in the Permian Basin. The Permian Basin is an unconventional hydrocarbon-producing region located in West Texas and southeastern New Mexico, and can include tight oil and tight gas reservoirs that benefit from hydraulic fracturing operations. The fracturing operation can be performed on a well in the Midland Basin, which is a sub-basin of the Permian Basin located in the eastern portion of the Permian Basin. The fracturing operation can be performed on a well in the Delaware Basin, which is a sub-basin of the Permian Basin located in the western portion of the Permian Basin. Wells in the Permian Basin, including the Midland Basin and Delaware Basin, can have lateral lengths of 15,000 feet, 20,000 feet, 25,000 feet, or longer, and can comprise hundreds of fracturing stages that can benefit from the erosion reduction and proppant transport improvements provided by single point fracturing with LWP particles.

In some embodiments, the method can be performed as a refracturing operation on an existing wellbore. Refracturing operations involve hydraulic fracturing of a wellbore that has been previously fractured, and can be performed to restimulate production from a well that has experienced production decline or to access reservoir intervals that were not adequately stimulated during the original fracturing operation. The method can be performed using fracture sleeves installed in the existing wellbore during the refracturing operation, and the combination of single point fracturing with LWP particles can provide improved proppant transport and reduced erosion of sleeve components during the refracturing operation. Refracturing operations can benefit from the fracture uniformity achievable through single point fracturing, as uniform fractures can provide more consistent restimulation of the reservoir compared to conventional refracturing techniques.

Although embodiments herein are described with respect to the unconventional hydrocarbon-containing product extraction, one skilled in the art will readily recognize that the methods, systems and equipment described herein are also suitable for application in other areas. For example, such applications may comprise recovery from conventional wells, among other applications within hydrocarbon management.

### Embodiments of this Disclosure

In one or more embodiments, this disclosure may be susceptible to various modifications and alternative forms, such as the following embodiments as noted below:

E1. A method for performing hydraulic fracturing operation via a wellbore to a subsurface formation, the method comprising:
(I) providing the wellbore, wherein the wellbore comprises a device having an erosion-prone feature during the hydraulic fracturing operation; and
(II) pumping a fracturing fluid comprising lightweight proppant (“LWP”) particles through the wellbore and through a cluster of injection ports into the subsurface formation, thereby creating a plurality of fractures in the subsurface formation, wherein the fracturing fluid contacts the erosion-prone feature.

E2. The method of E1, wherein the device comprises a fracturing sleeve, the sleeve comprising the cluster of injection ports.

E3. The method of E2, wherein the erosion-prone feature comprises a protrusion on the fracturing sleeve extending into a flow path of the fracturing fluid in the wellbore.

E4. The method of E3, wherein the protrusion comprises a shoulder, and the shoulder is at least part of the erosion-prone feature.

E5. The method of E4, wherein the shoulder is configured to engage with an isolation device to isolate an uphole portion of the wellbore from a downhole portion of the wellbore.

E6. The method of any of the preceding E1 to E5, wherein the LWP particles are present in the fracturing fluid at a concentration from 14 kilograms per cubic meter to 480 kilograms per cubic meter, based on a total volume of a carrier fluid.

E7. The method of any of the preceding E1 to E6, wherein the fracturing fluid further comprises non-LWP proppant particles having an apparent density higher than an apparent density of the LWP particles, and the LWP particles have a concentration from 10% to 50% by volume in the fracturing fluid, based on a total volume of all proppant particulates in the fracturing fluid, on a dry particle basis.

E8. The method of E7, wherein the LWP particles have a hardness lower than a hardness of the non-LWP proppant particles.

E9. The method of E7 or E8, wherein the LWP particles have a concentration from 10% to 33% by volume, based on the total volume of all proppant particulates in the fracturing fluid, on a dry particle basis.

E10. The method of any of the preceding E1 to E9, wherein step (II) comprises, in a single fracturing stage:
(Ila) pumping a first fracturing fluid into the subsurface formation via the wellbore; and subsequently
(IIb) pumping a second fracturing fluid differing from the first fracturing fluid into the subsurface formation via the wellbore,
wherein at least one of the first fracturing fluid and the second fracturing fluid comprises LWP particles.

E11. The method of E10, wherein at least one of the first fracturing fluid and the second fracturing fluid comprises non-LWP proppant particles having an apparent density higher than the apparent density of the LWP particles.

E12. The method of E11, wherein the LWP particles have a hardness lower than a hardness of the non-LWP proppant particles.

E13. The method of any of E10 to E12, wherein one of the first fracturing fluid and the second fracturing fluid comprises LWP particles and is free of non-LWP proppant particles, and the other fracturing fluid comprises non-LWP proppant particles and is free of LWP particles.

E14. The method of E13, wherein the non-LWP proppant particles comprise sand, and the LWP particles consist of coke particles.

E15. The method of any of E10 to E14, wherein the LWP particles constitute from 10% to 75% by volume of a total volume of all proppant particulates in the first fracturing fluid and the second fracturing fluid, on a dry particle basis.

E16. The method of any of the preceding E1 to E15, wherein in step (II), the fracturing fluid is pumped simultaneously through no more than three clusters of injection ports in the wellbore.

E17. The method of E16, wherein in step (II), the fracturing fluid is pumped through only one cluster of injection ports in the wellbore.

E18. The method of E17, wherein the one cluster of injection ports are present on a single fracturing sleeve.

E19. The method of any of E16 to E18, wherein the fracturing fluid is pumped into the subsurface formation at a flow rate of at least 30 barrels per minute per cluster of injection ports.

E20. The method of any of E16 to E19, wherein the fracturing fluid is pumped into the subsurface formation at a flow rate of no more than 200 barrels per minute per cluster of injection ports.

E21. The method of any of E16 to 18, wherein in step (II), the plurality of fractures have a half-length of at least 200 feet.

E22. The method of any of E16 to 18, wherein in step (II), the plurality of fractures have a half-length of no more than 4,000 feet.

E23. The method of any of E1 to E22, wherein the LWP particles have an apparent density in a range from 1.0 g/cm³ to 2.0 g/cm³.

E24. The method of any of the preceding E1 to E23, wherein at least 50 wt % of the LWP particles have particle sizes from 88 μm to 250 μm.

E25. The method of any of E11, E13, and E14, wherein the LWP particles have a D50 that is smaller than a D50 of the non-LWP proppant particles.

E26. The method of any of the preceding E1 to E25, wherein the LWP particles have a sphericity of from 0.4 to 0.9.

E27. The method of any of the preceding E1 to E26, wherein the LWP particles comprise petroleum coke.

E28. The method of E27, wherein the petroleum coke is selected from (i) fluid coke, (ii) flexicoke, (iii) thermally post-treated delayed coke, and (iv) combinations of two or more of (i), (ii), and (iii).

E29. The method of any of the preceding E1 to E28, wherein:
the wellbore comprises a lateral having a toe and a heel; and
during a total duration of the fracturing operation through a full length of the wellbore, the fracturing fluid used to fracture a stage including the toe comprises (i) more LWP particles than the fracturing fluid used to fracture a stage including the heel, and (ii) less non-LWP proppant particles than the fracturing fluid used to fracture the stage including the heel.

E30. The method of E29, wherein:

from the stage including the toe to the stage including the heel, the fracturing fluids used comprise decreasing amount of LWP particles and increasing amount of non-LWP proppant particles.

E31. The method of any of the preceding E1 to E30, wherein the fracturing fluid comprises a carrier fluid and proppant particles, and the carrier fluid is selected from:
(i) a slickwater-based carrier fluid having a viscosity from 1 to 20 centipoise;
(ii) a linear-gel-based carrier fluid having a viscosity from 20 to 40 centipoise; and
(iii) a crosslinked gel-based carrier fluid having a viscosity from 100 to 500 centipoise.

E32. The method of any of the preceding E1 to E31, wherein the device comprises an instrument housing used to collect and/or transmit data.

E33. The method of any of the preceding E1 to E32, wherein the fracturing fluid is prepared by a process comprising adjusting a viscosity thereof to at least 1 centipoise.

E34. A method for performing via a wellbore comprising a plurality of fracturing sleeves to a subsurface formation, the method comprising:
(A) deploying an isolation device into the wellbore;
(B) engaging the isolation device with a fracturing sleeve in the wellbore;
(C) shifting the fracturing sleeve from a closed position to an open position, thereby exposing an injection port;
(D) pumping a fracturing fluid comprising lightweight proppant (LWP) particles through the wellbore and through the exposed injection port into the subsurface formation, thereby creating a plurality of fractures in the subsurface formation.

E35. The method of E34, wherein during step (D), no more than three of the plurality of the fracturing sleeves are in an open position allowing the fracturing fluid to pass through flow ports therein.

E36. The method of E34, wherein during step (D), only one of the fracturing sleeves is in the open position allowing the fracturing fluid to pass through flow port therein.

E37. The method of any of E34 to E36, wherein the sleeve has a shoulder extending into the wellbore for engaging with the isolation device, the shoulder contacts the fracturing fluid during the hydraulic fracturing operation and is subjected to erosion.

E38. The method of any of E34 to E37, wherein, from a stage including the toe to a stage including the heel, the fracturing fluids used comprise decreasing amount of LWP particles and increasing amount of non-LWP proppant particles.

E39. The method of any of E34 to E38, wherein the fracturing fluid further comprises non-LWP proppant particles, and wherein the LWP particles exhibit a lower hardness than the non-LWP proppant particles.

E40. The method of any of E34 to E39, wherein the fracturing fluid further comprises non-LWP proppant particles, the non-LWP proppant particles have an apparent density higher than an apparent density of the LWP particles, and the LWP particles have a concentration from 10% to 50% by volume in the fracturing fluid, based on a total volume of all proppant particulates in the fracturing fluid, on a dry particle basis.

E41. The method of E40, wherein the LWP particles have a concentration from 10% to 33% by volume, based on the total volume of all proppant particulates in the fracturing fluid, on a dry particle basis.

E42. The method of any of E34 to E41, wherein step (D) comprises, in a single fracturing stage:
(Da) pumping a first fracturing fluid into the subsurface formation via the wellbore; and subsequently
(Db) pumping a second fracturing fluid differing from the first fracturing fluid into the subsurface formation via the wellbore,
wherein at least one of the first fracturing fluid and the second fracturing fluid comprises LWP particles.

E43. The method of E42, wherein at least one of the first fracturing fluid and the second fracturing fluid comprises non-LWP proppant particles having an apparent density higher than the apparent density of the LWP particles.

E44. The method of E42 or E43, wherein the first fracturing fluid comprises LWP particles and the second fracturing fluid comprises non-LWP proppant particles.

E45. The method of any of E42 to E44, wherein the first fracturing fluid is free of non-LWP proppant particles and the second fracturing fluid is free of LWP particles.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of this disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, this disclosure comprises all alternatives, modifications, and equivalents falling within the true spirit and scope of the appended claims.

What is claimed is:

1. A method for performing hydraulic fracturing operation via a wellbore to a subsurface formation, the method comprising:
(I) providing the wellbore, wherein the wellbore comprises a device having an erosion-prone feature during the hydraulic fracturing operation; and
(II) pumping a fracturing fluid comprising lightweight proppant (“LWP”) particles through the wellbore and through a cluster of injection ports into the subsurface formation, thereby creating a plurality of fractures in the subsurface formation, wherein the fracturing fluid contacts the erosion-prone feature.

2. The method of claim 1, wherein the device comprises a fracturing sleeve, the sleeve comprising the cluster of injection ports.

3. The method of claim 2, wherein the erosion-prone feature comprises a protrusion on the fracturing sleeve extending into a flow path of the fracturing fluid in the wellbore.

4. The method of claim 3, wherein the protrusion comprises a shoulder, and the shoulder is at least part of the erosion-prone feature.

5. The method of claim 4, wherein the shoulder is configured to engage with an isolation device to isolate an uphole portion of the wellbore from a downhole portion of the wellbore.

6. The method of claim 1, wherein the LWP particles are present in the fracturing fluid at a concentration from 14 kilograms per cubic meter to 480 kilograms per cubic meter, based on a total volume of a carrier fluid.

7. The method of claim 1, wherein the fracturing fluid further comprises non-LWP proppant particles having an apparent density higher than an apparent density of the LWP particles, and the LWP particles have a concentration from 10% to 50% by volume in the fracturing fluid, based on a total volume of all proppant particulates in the fracturing fluid, on a dry particle basis.

8. The method of claim 7, wherein the LWP particles have a hardness lower than a hardness of the non-LWP proppant particles.

9. The method of claim 7, wherein the LWP particles have a concentration from 10% to 33% by volume, based on the total volume of all proppant particulates in the fracturing fluid, on a dry particle basis.

10. The method of claim 1, wherein step (II) comprises, in a single fracturing stage:
(IIa) pumping a first fracturing fluid into the subsurface formation via the wellbore; and subsequently
(IIb) pumping a second fracturing fluid differing from the first fracturing fluid into the subsurface formation via the wellbore,
wherein at least one of the first fracturing fluid and the second fracturing fluid comprises LWP particles.

11. The method of claim 10, wherein at least one of the first fracturing fluid and the second fracturing fluid comprises non-LWP proppant particles having an apparent density higher than the apparent density of the LWP particles.

12. The method of claim 11, wherein the LWP particles have a hardness lower than a hardness of the non-LWP proppant particles.

13. The method of claim 10, wherein one of the first fracturing fluid and the second fracturing fluid comprises LWP particles and is free of non-LWP proppant particles, and the other fracturing fluid comprises non-LWP proppant particles and is free of LWP particles.

14. The method of claim 13, wherein the non-LWP proppant particles comprise sand, and the LWP particles consist of coke particles.

15. The method of claim 10, wherein the LWP particles constitute from 10% to 75% by volume of a total volume of all proppant particulates in the first fracturing fluid and the second fracturing fluid, on a dry particle basis.

16. The method of claim 1, wherein in step (II), the fracturing fluid is pumped simultaneously through no more than three clusters of injection ports in the wellbore.

17. The method of claim 16, wherein in step (II), the fracturing fluid is pumped through only one cluster of injection ports in the wellbore.

18. The method of claim 17, wherein the one cluster of injection ports are present on a single fracturing sleeve.

19. The method of claim 16, wherein the fracturing fluid is pumped into the subsurface formation at a flow rate of at least 30 barrels per minute per cluster of injection ports.

20. The method of claim 16, wherein the fracturing fluid is pumped into the subsurface formation at a flow rate of no more than 200 barrels per minute per cluster of injection ports.

21. The method of claim 16, wherein in step (II), the plurality of fractures has an average half-length of at least 200 feet.

22. The method of claim 16, wherein in step (II), the plurality of fractures has an average half-length of no more than 4,000 feet.

23. The method of claim 1, wherein the LWP particles have an apparent density in a range from 1.0 g/cm³ to 2.0 g/cm³.

24. The method of claim 1, wherein at least 50 wt % of the LWP particles have particle sizes from 88 μm to 250 μm.

25. The method of claim 11, wherein the LWP particles have a D50 that is smaller than a D50 of the non-LWP proppant particles.

26. The method of claim 1, wherein the LWP particles have a sphericity of from 0.4 to 0.9.

27. The method of claim 1, wherein the LWP particles comprise petroleum coke.

28. The method of claim 27, wherein the petroleum coke is selected from (i) fluid coke, (ii) flexicoke, (iii) thermally post-treated delayed coke, and (iv) combinations of two or more of (i), (ii), and (iii).

29. The method of claim 1, wherein:
the wellbore comprises a lateral having a toe and a heel; and
during a total duration of the fracturing operation through a full length of the wellbore, the fracturing fluid used to fracture a stage including the toe comprises (i) more LWP particles than the fracturing fluid used to fracture a stage including the heel, and (ii) less non-LWP proppant particles than the fracturing fluid used to fracture the stage including the heel.

30. The method of claim 29, wherein:
from the stage including the toe to the stage including the heel, the fracturing fluids used comprise decreasing amount of LWP particles and increasing amount of non-LWP proppant particles.

31. The method of claim 1, wherein the fracturing fluid comprises a carrier fluid and proppant particles, and the carrier fluid is selected from:
(i) a slickwater-based carrier fluid having a viscosity from 1 to 20 centipoise;
(ii) a linear-gel-based carrier fluid having a viscosity from 20 to 40 centipoise; and
(iii) a crosslinked gel-based carrier fluid having a viscosity from 100 to 500 centipoise.

32. The method of claim 1, wherein the device comprises an instrument housing used to collect and/or transmit data.

33. The method of claim 1, wherein the fracturing fluid is prepared by a process comprising adjusting a viscosity thereof to at least 1 centipoise.

34. A method for performing hydraulic fracturing to a subsurface formation via a wellbore comprising a plurality of fracturing sleeves, the method comprising:
(A) deploying an isolation device into the wellbore;
(B) engaging the isolation device with a fracturing sleeve in the wellbore;
(C) shifting the fracturing sleeve from a closed position to an open position, thereby exposing an injection port;
(D) pumping a fracturing fluid comprising lightweight proppant (LWP) particles through the wellbore and through the exposed injection port into the subsurface formation, thereby creating a plurality of fractures in the subsurface formation.

35. The method of claim 34, wherein during step (D), no more than three of the plurality of the fracturing sleeves are in an open position allowing the fracturing fluid to pass through flow ports therein.

36. The method of claim 34, wherein during step (D), only one of the fracturing sleeves is in the open position allowing the fracturing fluid to pass through flow port therein.

37. The method of claim 34, wherein the sleeve has a shoulder extending into the wellbore for engaging with the isolation device, the shoulder contacts the fracturing fluid during the hydraulic fracturing operation and is subjected to erosion.

38. The method of claim 34, wherein, from a stage including the toe to a stage including the heel, the fracturing fluids used comprise decreasing amount of LWP particles and increasing amount of non-LWP proppant particles.

39. The method of claim 34, wherein the fracturing fluid further comprises non-LWP proppant particles, and wherein the LWP particles exhibits a lower hardness than the non-LWP proppant particles.

40. The method of claim 34, wherein the fracturing fluid further comprises non-LWP proppant particles, the non-LWP proppant particles have an apparent density higher than an apparent density of the LWP particles, and the LWP particles have a concentration from 10% to 50% by volume in the fracturing fluid, based on a total volume of all proppant particulates in the fracturing fluid, on a dry particle basis.

41. The method of claim 40, wherein the LWP particles have a concentration from 10% to 33% by volume, based on the total volume of all proppant particulates in the fracturing fluid, on a dry particle basis.

42. The method of claim 34, wherein step (D) comprises, in a single fracturing stage:
(Da) pumping a first fracturing fluid into the subsurface formation via the wellbore; and subsequently
(Db) pumping a second fracturing fluid differing from the first fracturing fluid into the subsurface formation via the wellbore,
wherein at least one of the first fracturing fluid and the second fracturing fluid comprises LWP particles.

43. The method of claim 42, wherein at least one of the first fracturing fluid and the second fracturing fluid comprises non-LWP proppant particles having an apparent density higher than the apparent density of the LWP particles.

44. The method of claim 42, wherein the first fracturing fluid comprises LWP particles and the second fracturing fluid comprises non-LWP proppant particles.

45. The method of claim 42, wherein the first fracturing fluid is free of non-LWP proppant particles and the second fracturing fluid is free of LWP particles.
